(19) United States
(12) Patent Application Publication
(10) Pub. No.: US 2019/0132068 A1
(43) Pub. Date: May 2, 2019

(54) RECEPTION DEVICE, RECEPTION METHOD, AND PROGRAM

(71) Applicant: SHARP KABUSHIKI KAISHA, Sakai City, Osaka (JP)

(72) Inventors: HIDEKI SUZUKI, Sakai City (JP); TAKAMASA SHIMIZU, Sakai City (JP); YOSHIYASU OGASAWARA, Sakai City (JP); TOMOO NISHIGAKI, Sakai City (JP)

(73) Assignee: SHARP KABUSHIKI KAISHA, Sakai City, Osaka (JP)

(21) Appl. No.: 16/078,312

(22) PCT Filed: Jul. 11, 2017
(86) PCT No.: PCT/JP2017/025249

§ 371 Date: Aug. 21, 2018

(30) Foreign Application Priority Data
Jul. 15, 2016 (JP) 2016-140220

(51) Int. Cl. H04H 40/18; H04H 60/37; H04N 5/60; H04H 20/33; H04H 60/25

(52) U.S. Cl. CPC H04H 40/18; H04H 60/37; H04H 60/25; H04H 20/33; H04N 5/607

(57) ABSTRACT

A reception device detects whether or not there has been updating of configuration information including correlation information correlated with audio data provided in a program from reception signals received in a broadcast, selects one of a plurality of audio data in accordance with operating input, and includes a decoding unit that decodes audio data that the selecting unit has selected. When the configuration information is updated, the selecting unit selects, out of correlation information included in the configuration information that has been updated, audio data corresponding to correlation information including a predetermined element that is the same as correlation information corresponding to audio data selected before updating.

### TECHNICAL FIELD

Some aspects of the present invention relate to a reception device, a reception method, and a program.

The present application claims the benefit of Japanese Patent Application No. 2016-140220 filed Jul. 15, 2016, which is hereby incorporated by reference herein in its entirety.

### BACKGROUND ART

Broadcasting audio of a greater number of reproduction formats is being studied as part of advancement of broadcasting services, to provide audiences with programs having high sound quality in addition to image quality. For example, there are cases where the surround format (e.g., 5.1 ch) that has more audio channels than the conventional monaural audio (1.0 ch (channel)) and stereo audio (2.0 ch) is provided. There are some television reception devices that can reproduce the surround format audio as it is, but there are some reception devices that can only reproduce monaural audio, or only monaural audio and stereo audio. There are cases where reception devices that are not compatible with the surround format perform downmixing processing to convert the surround audio into audio data of a fewer number of audio channels.

Downmixing processing includes processing to assign audio data in audio channels before conversion into one of multiple audio channels after conversion, and to generate audio data of audio channels after conversion by compositing (adding) audio data of channels before conversion.

In next-generation television broadcasting service such as 4K and 8K ultra-high definition television broadcasting (UHDTV: Ultra High Definition Television) for example, simulcast broadcasting is planned, which is a service where audio of multiple different reproduction formats or audio of multiple languages are broadcast for a single program.

### CITATION LIST

### Patent Literature

PTL 1: Japanese Unexamined Patent Application Publication No. 2016-92698

### Non Patent Literature

NPL 1: The Association for Promotion of Advanced Broadcasting Services, Selection of Audio Assets, “NEXTVF TR-0004 Operational Guidelines for Advanced Digital Satellite Broadcasting”, Mar. 30, 2016, Edition 1.1, Part 2, Advanced BS Digital Broadcast Reception Device Specifications 4.7.1, 2-16 through 2-20

### SUMMARY OF INVENTION

### Technical Problem

However, conventional reception devices are not necessarily compatible with audio data of all formats. Accordingly, it is conceivable that downmixing processing will be performed based on the received audio data, and audio will be reproduced based on the generated audio data. The properties of downmixing processing depend on the performance of a device (e.g., (Integrated Circuit) IC chip) executing the processing. Accordingly, problems may occur, such as audio of some audio channels (e.g., the voice of a commentator in a sports program) not being able to be selectively received or deleted, deterioration of quality such as noise or distortion being added by the processing, and so on. These problems are due to downmixing processing at the reception device not being taken into consideration at the stage of producing the program. There were also some cases with conventional reception devices where decoding processing of audio data of all audio channels received was first performed, regardless of reproduction capabilities, and thereafter downmixing processing was performed in accordance with reproduction capabilities. With reproduction formats having a great number of audio channels, such as the surround format (22.2 ch) in particular, advanced decoding processing capabilities are required, and further, deterioration in quality due to cumbersome downmixing processing is marked.

Accordingly, it is desirable that reception devices receiving simulcast broadcasting will enable users to select desired audio data without hesitation. For example, PTL 1 describes a reception device where the presence of audio data of multiple formats is detected in one program from data that has been received, notification information indicating which of the multiple formats can be processed is output, and selection of one of the formats that can be processed out of the multiple formats in accordance with operation input is performed. NPL 1 describes reselecting one of reproducible audio in a case where a selected audio is dropped while viewing a program.

However, the reception devices described in PTL 1 and NPL 1 do not handle change in audio data making up programs. That is to say, in a case where programs are switched while the user is watching broadcasting, predetermined audio data is uniformly selected regardless of the audio data selected before switching.

Some aspects of the present invention have been made in light of the above points, and provided are a reception device, a reception method, and a program, whereby desired audio data can be selected when programs are changed.

### Solution to Problem

Some aspects according to the present invention have been made to solve the above problems, and one aspect of the present invention is a reception device that includes a detecting unit that detects whether or not there has been updating of configuration information including correlation information correlated with audio data provided in a program from reception signals received in a broadcast, a selecting unit that selects one of a plurality of audio data in accordance with operating input, and a decoding unit that decodes audio data that the selecting unit has selected. When the configuration information is updated, the selecting unit selects, out of correlation information included in the configuration information that has been updated, audio data corresponding to correlation information including a predetermined element that is the same as correlation information corresponding to audio data selected before updating.

### Advantageous Effects of Invention

According to some aspects of the present invention, desired audio data can be selected when programs are changed.

### BRIEF DESCRIPTION OF DRAWINGS

FIG. 1 is a block diagram of illustrating the configuration of a broadcast system according to a first embodiment.

FIG. 2 is a block diagram illustrating the configuration of a transmission device according to the first embodiment.

FIG. 3 is a diagram illustrating an example of MPT.

FIG. 4 is a diagram illustrating an example of an MH-audio component descriptor.

FIG. 5 is a diagram illustrating examples of component types.

FIG. 6 is a diagram illustrating setting examples of MH-audio component descriptors.

FIG. 7 is a block diagram illustrating the configuration of a reception device according to the first embodiment.

FIG. 8 is a block diagram illustrating the configuration of a control unit according to the first embodiment.

FIG. 9 is a diagram illustrating an example of an audio reproduction format table.

FIG. 10 is a flowchart illustrating reception processing according to the first embodiment.

FIG. 11 is a flowchart illustrating reproduction format determination processing according to the first embodiment.

FIG. 12 is a diagram illustrating an example MH-EIT.

FIG. 13 is a flowchart illustrating reception processing according to a second embodiment.

FIG. 14 is a block diagram illustrating the configuration of a control unit according to a third embodiment.

FIG. 15 is a diagram illustrating an example of a format selection button according to the third embodiment.

FIG. 16 is a flowchart illustrating reception processing according to the third embodiment.

FIG. 17 is a block diagram illustrating the configuration of a control unit according to a fourth embodiment.

FIG. 18 is a flowchart illustrating reception processing according to the fourth embodiment.

FIG. 19 is a block diagram illustrating the configuration of a control unit according to a fifth embodiment.

FIG. 20 is a diagram illustrating an example of a format selection button according to the fifth embodiment.

FIG. 21 is a diagram illustrating an example of reception processing according to a sixth embodiment.

### DESCRIPTION OF EMBODIMENTS

### First Embodiment

A first embodiment of the present invention will be described with reference to the drawings.

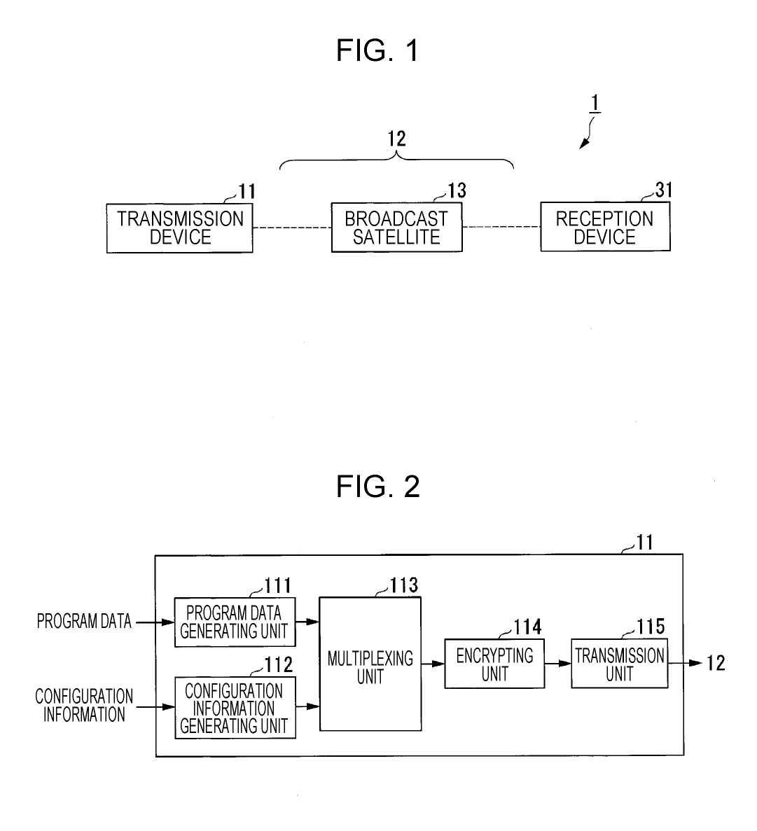

FIG. 1 is a block diagram illustrating the configuration of a broadcast system 1 according to the present invention. The broadcast system 1 is configured including a transmission device 11 and a reception device 31. The transmission device 11 makes up broadcasting facilities of a broadcaster, for example. The reception device 31 receives broadcast programs broadcast from the transmission device 11, displays video of received broadcast programs, and reproduces audio of the broadcast programs. The reception device 31 is installed in homes, businesses, and so forth, for example.

The transmission device 11 transmits program data representing a broadcast program to the reception device 31 via a broadcast transmission path 12. The program data includes, for example, audio data and video data. The audio data is not restricted to one type of audio data, and may include audio data of multiple reproduction formats at the same time.

A reproduction format indicates the number of audio channels and the layout of speakers relating to reproduction, and sometimes is also referred to as audio mode. Examples of a reproduction format include stereo 2 ch, surround 5.1 ch, and so forth. A service where audio data of such multiple reproduction formats is provided in a single program data is referred to as simulcast. Simulcast is also referred to as simulcast broadcasting. In the following description, this service itself, or audio provided by this service, may be referred to as simulcast audio.

The broadcast transmission path 12 is a transmission path that performs one-way transmission of various types of data transmitted by the transmission device 11, to many and unspecified reception devices 31 at the same time. The broadcast transmission path 12 is radio waves (broadcast waves) of a predetermined frequency band relayed via a broadcast satellite 13, for example. Part of the broadcast transmission path 12 may include a communication line, e.g., a communication line from the transmission device 11 to transmission facilities for transmitting the radio waves from the transmission device 11.

The reception device 31 displays video of a program based on program data received from the transmission device 11 via the broadcast transmission path 12, and reproduces audio of the program. The reception device 31 detects the presents of audio data of multiple formats, i.e., simulcast audio, from the received program data. The reception device 31 has a decoding unit to decode audio data of at least one format of the multiple formats included in the program data, and selects one of the formats out of the multiple formats that the decoding unit can process. The reception device 31 is an electronic device having capabilities of receiving television broadcasts, such as a television receiver, video recorder, or the like, for example.

### Configuration of Transmission Device

Next, the configuration of the transmission device 11 according to the present embodiment will be described.

FIG. 2 is a block diagram illustrating the configuration of the transmission device 11 according to the present embodiment. The transmission device 11 includes a program data generating unit 111, a configuration information generating unit 112, a multiplexing unit 113, an encrypting unit 114, and a transmission unit 115.

The program data generating unit 111 obtains video data representing video and audio data representing audio, making of the broadcast program. The program data generating unit 111 obtains video data that has been encoded by a predetermined video encoding format. The predetermined video encoding format is a format stipulated by, for example, ISO/IEC 23008 HEVC (International Organization for Standardization/International Electronical Commission 23008 Part 2 High Efficiency Video Coding, also referred to simply as HEVC). The program data generating unit 111 obtains audio data encoded by a predetermined audio encoding format. The predetermined audio encoding format is an audio encoding format stipulated by, for example, ISO/IEC 14496 Part 3 (also referred to as MPEG-4 audio). The program data generating unit 111 may obtain audio data of multiple reproduction formats at the same time in one program. The program data generating unit 111 generates program data of a predetermined format from the obtained video data and audio data, and outputs the generated program data to the multiplexing unit 113. The program data of the predetermined format is an MPU (Media Processing Unit) stipulated by, for example, ISO/IEC 23008 Part 1 MMT (MPEG Media Transport, referred to simply as MMT). Each MPU includes image data or audio data of an increment where decoding processing of video or audio can be performed.

The configuration information generating unit 112 obtains configuration element information that is information for configuring broadcast programs and services provided along with broadcasting. The configuration element information includes lists of assets that are configuration elements of broadcast programs and services, information indicating prerequisites thereof, e.g., information indicating whether or not multi-view services are present in a program. Assets are element data that are configuration elements of the program, such as audio data of individual streams, video data, and so forth, for example. The configuration information generating unit 112 generates configuration information of a predetermined format from the obtained configuration element information, and outputs the generated configuration information to the multiplexing unit 113. The configuration information of a predetermined format is, for example, an MPT (MMT Package Table) making up MMT-SI (MMT-System information). An example of MPT will be described later.

The multiplexing unit 113 multiplexes the program data input from the program data generating unit 111 and the obtained information input from the configuration information generating unit 112, and generates multiplexed data of a predetermined format (e.g., TLV (Type Length Value) packets). The multiplexing unit 113 outputs the generated multiplexed data to the encrypting unit 114.

The encrypting unit 114 encrypts the multiplexed data input from the multiplexing unit 113 using a predetermined encryption format (e.g., AES (Advanced Encryption Standard)). The encrypting unit 114 outputs the encrypted multiplexed data to the transmission unit 115.

The transmission unit 115 transmits the multiplexed data input from the encrypting unit 114 to the reception device 31 via the broadcast transmission path 12. The transmission unit 115 modulates carrier waves having a predetermined carrier frequency by the multiplexed data that is baseband signals, and emits radio waves (broadcast waves) of a channel band corresponding to the carrier frequency from an antenna (omitted from illustration).

### Data Structure of MPT

Next, an example of an MPT included in configuration information will be described.

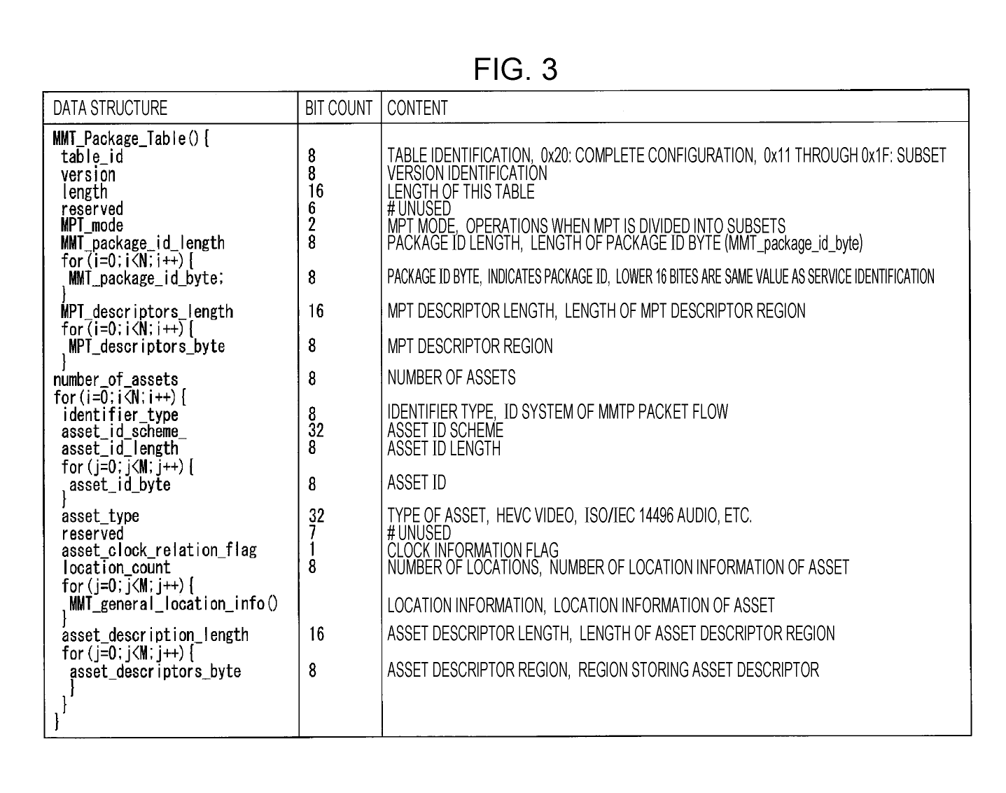

FIG. 3 is a diagram illustrating an example of an MPT In the example illustrated in FIG. 3, the MPT includes an MPT descriptor region (MPT_descirtors_byte) and an asset type (asset_type) for each asset. The MPT descriptor region (MPT_descirtors_byte) is a region where an MPT descriptor is described. The configuration information generating unit 112 generates an MH-audio component descriptor (MH-Audio_Component_Descrioptor( )). The MH-audio component descriptor (MH-Audio_Component_Descriptor( )) is a descriptor where parameters relating to audio data making up the program are described. In a case of providing simulcast audio, the configuration information generating unit 112 generates an MH-audio component descriptor (MH-Audio_Component_Descriptor( ) ) for each reproduction format. The configuration information generating unit 112 includes the generated MH-audio component descriptor (MH-Audio_Component_Descriptor( )) in the MPT descriptor region (MPT_descriptors_byte). Described in the asset type (asset_type) is code indicating the type of asset. The configuration information generating unit 112 describes hcv1 indicating video data encoded by HEVC and mp4a indicating audio data encoded by MPEG-4 audio.

### Data Structure of MH-Audio Component Descriptor

Next, an example of an MH-audio component descriptor will be described.

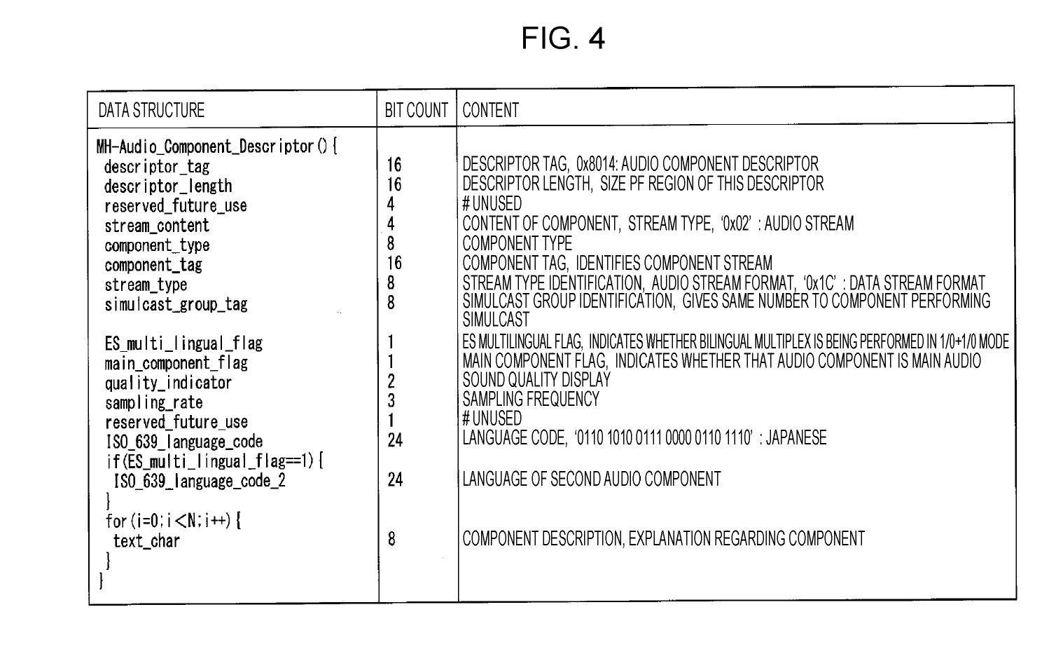

FIG. 4 is a diagram illustrating an example of an MH-audio component descriptor. In the example illustrated in FIG. 4, the MH-audio component descriptor (MH-Audio_Component_Descriptor( )) includes component type (component_type), component tag (component_tag), simulcast group identification (simulcast_group_tag), and main component, flag (main_component_tag). Described in the component type (component_type) is a No. indicating reproduction format. Nos. for identifying component streams of audio data of each reproduction format are described in the component tag (component_tag). Described in simulcast group identification (simulcast_group_tag) is the same No. for audio data belonging to a group of audio data regarding which one simulcast is performed. Note that a particular code ‘OxFF’ is described for audio data regarding which simulcast is not performed. Accordingly, in a case of providing simulcast audio, the configuration information generating unit 112 describes in simulcast group identification (simulcast_group_tag) a No. other than ‘0xFF’ that is common among reproduction formats. In a case of not providing simulcast audio, the configuration information generating unit 112 describes ‘OxFF’ in simulcast group identification (simulcast_group_tag). The main component flag (main_component_tag) is a flag indicating whether that audio data is the main audio or not. For example, as the main audio, a reproduction format that is reproducible at any reception device, such as single monaural 1 ch (single-channel monaural), for example, may be specified as the main audio.

Next, reproduction formats described in component type (component_type) will be described.

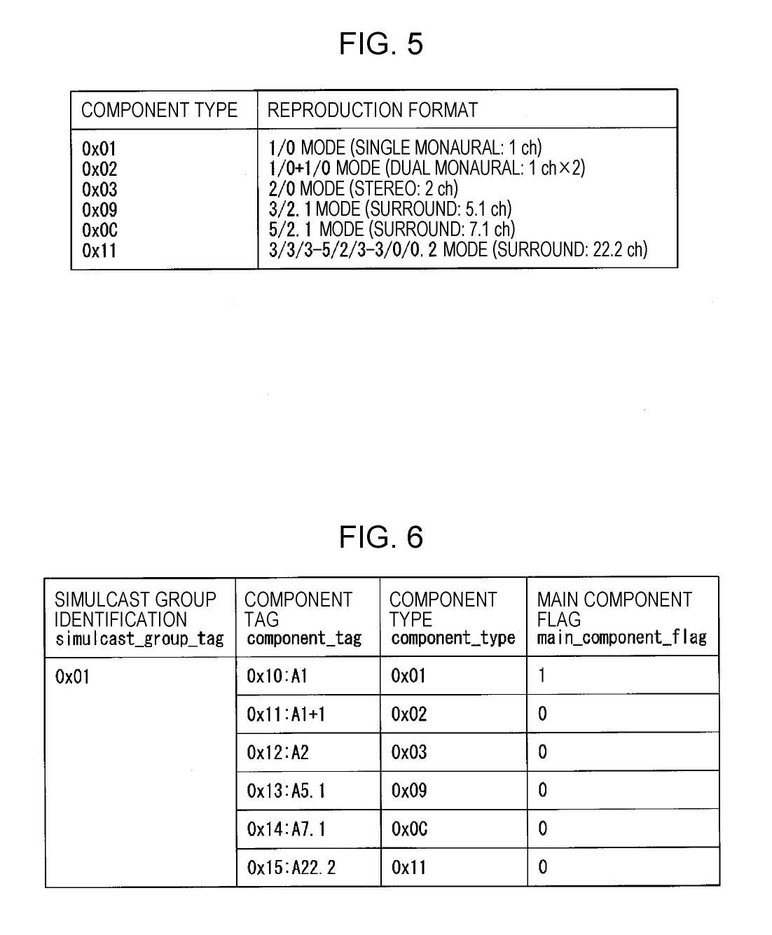

FIG. 5 is a diagram illustrating an example of component types. Listed as Nos. indicating component types are ‘0x01’, ‘0x02’, ‘0x03’, ‘0x09’, ‘0x0C’, and ‘0x11’. The ‘0x01’, ‘0x02’, ‘0x03’, ‘0x09’, ‘0x0C’, and ‘ox11’ are values respectively indicating 1/0 mode, 1/0+1/0 mode, 2/0 mode, 3/2.1 mode, 5/2.1 mode, and 3/3/3-5/2/3-3/0/0.2 mode, as reproduction formats. Note that “so-and-so/such-and-such” means that, regarding the layout of reproducing speakers with the listening point as a reference, a so-and-so count (so-and-so audio channels) to the front, and such-and-such count (such-and-such. audio channels) to the rear. The numerical values under the decimals indicate the number of audio channels for reproducing low range audio. Note that an audio channel means a channel that is an increment of audio reproduction, and is different from broadcast channels that indicate frequency bands of broadcast waves. Accordingly, 1/0 mode indicates single monaural 1 ch. 1/0+1/0 mode indicates dual monaural 1 ch×2. 2/0 mode indicates stereo 2 ch. 3/2.1 mode indicates surround 5.1 ch. 5/2.1 mode indicates surround 7.1 ch. 3/3/3-5/2/3-3/0/0.2 mode indicates surround 22.2 ch. The 3/3/3 in 3/3/3-5/2/3-3/0/0.2 mode indicates that the speaker layout for the upper layer is three each to the front, side, and rear with the listening point as a reference. 5/2/3 indicates that the speaker layout for the middle layer is five, two, and three, respectively to the front, side, and rear with the listening point as a reference. 3/0/0.2 indicates that the speaker layout for the lower layer is five, zero, and two, respectively to the front, side, and rear with the listening point as a reference. Note however, that the two channels at the rear in the lower layer are each a channel for reproducing low range audio.

### Example of MH-Audio Component Descriptor

Next, an example of setting each component group by the configuration information generating unit 112 will be described, by way of an example where simulcast audio made up of six reproduction format, which are audio A1, A1+1, A2, A5.1, A7/.1, and A22.2, is provided.

FIG. 6 is a diagram illustrating a setting example of MH-audio component descriptors. In the example illustrated in the first column in FIG. 6, a common No. ‘0x01’ is set as a simulcast group identification (simulcast_group_tag) for audio A1, A1+1, A2, A5.1, A7.1, and A22.2. This setting indicates that simulcast audio is provided by the six reproduction formats. In the second column, component tags (component_tag) that are different from each other, namely ‘0x10’, ‘0x11’, ‘0x12’, ‘0x13’, ‘0x14’, and ‘0x15’ are set respectively for the audio A1, A1+1, A2, A5.1, A7.1, and A22.2. According to this setting, each audio data is recognized. In the third column, component types (component _type) that are different from each other, are set respectively for the audio A1, A1+1, A2, A5.1, A7.1, and A22.2. This setting indicates that the reproduction formats of audio A1, A1+1, A2, A5.1, A7.1, and A22.2, respectively are single monaural 1 ch, dual monaural 1 ch×2, stereo 2 ch, surround 5.1 ch, surround 7.1 ch, and surround 22.2 ch. In the fourth column, the main component flag (main_component_tag) is set to ‘1’ for the audio A1, and the main component flag (main_component_tag) is set to ‘0’ for the audio A1+1, A2, A5.1, A7.1, and A22.2. This setting indicates that the audio A1 is the main audio, and that audio A1+1, A2, A5.1, A7.1, and A22.2 each are sub-audio.

### Configuration of Reception Device

Next, the configuration of the reception device 31 will be described.

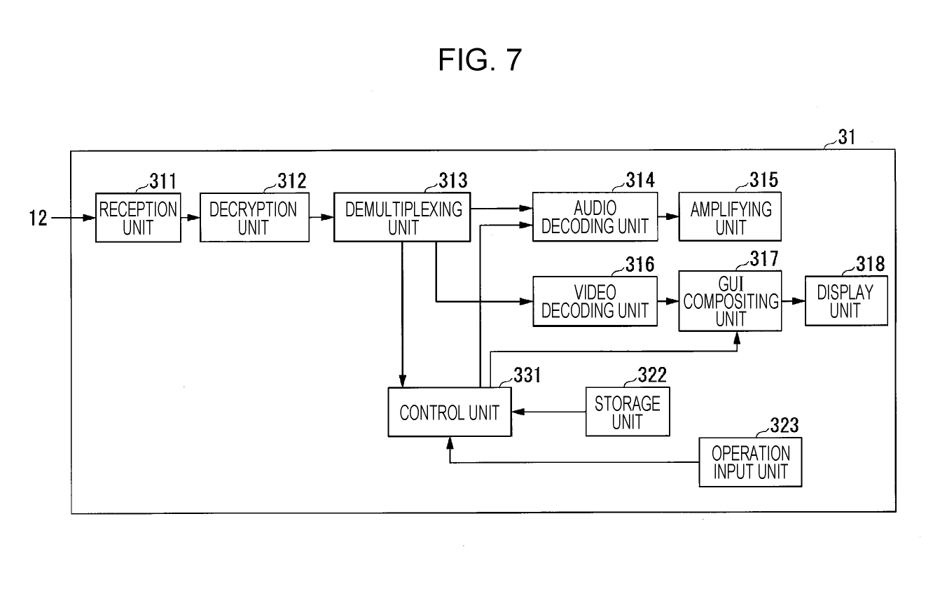

FIG. 7 is a block diagram illustrating the configuration of the reception device 31 according to the present embodiment. The reception device 31 is configured including a reception unit 311 (tuner), a decryption unit 312, a demultiplexing unit 313, an audio decoding unit 314, an amplifying unit 315, a video decoding unit 316, a GUI compositing unit 317, a display unit 318, a storage unit 322, an operation input unit 323, and a control unit 331.

The reception unit 311 receives broadcast waves that the transmission device 11 has transmitted via the broadcast transmission path 12. The reception unit 311 identifies a broadcast channel band in accordance with the broadcast channel specified by broadcast channel signals input from the control unit 331. The reception unit 311 demodulates received signals of the broadcast channel band received as broadcast waves, into multiplexed data that is baseband signals. The reception unit 311 outputs the demodulated multiplexed data to the decryption unit 312. The decryption unit 312 decrypts the multiplexed data (encrypted) input from the reception unit 311 by a decryption format corresponding to the format used by the encrypting unit 114 of the transmission device 11 (e.g., AES), and generates decrypted multiplexed data. The decryption unit 312 outputs the generated multiplexed data to the demultiplexing unit 313.

The demultiplexing unit 313 divides the multiplexed data input from the decryption unit 312 into program data and configuration information. The demultiplexing unit 313 outputs the configuration information to the control unit 331. The demultiplexing unit 313 also extracts audio data and video data from the program data. The demultiplexing unit 313 outputs the extracted audio data to the audio decoding unit 314, and outputs the video data to the video decoding unit 316.

The audio decoding unit 314 decodes the audio data input form the demultiplexing unit 313 using a decoding format corresponding to the encoding format used for encoding (e.g., MPEG-4 audio), and generates the original audio data. The decoded audio data is data indicating the level of audio at each point in time. In a case where simulcast audio is provided, audio data of multiple reproduction formats may be input to the audio decoding unit 314, and a format selection signal input from the control unit 331. A format selection signal is a signal instructing an audio of the audio of multiple reproduction formats. The audio decoding unit 314 performs decoding regarding audio data, out of the audio data of multiple reproduction formats, regarding which this device is capable of processing and which has been instructed by the format selection signal, thereby generating the original audio data. The audio decoding unit 314 outputs the decoded original audio data to the amplifying unit 315. Accordingly, in a case where simulcast audio is provided, audio of the reproduction format instructed by the format selection signal is reproduced at the amplifying unit 315. Note that in a case where there is no input of a format selection signal, the audio decoding unit 314 outputs the original audio data according to the main audio to the amplifying unit 315.

The amplifying unit 315 reproduces audio based on the audio data input from the audio decoding unit 314. The amplifying unit 315 is configured including a speaker, for example. The amplifying unit 315 includes speakers of a number at least equivalent to a predetermined number of channels. The predetermined number of channels is equivalent to the number of channels specified in a reproduction format regarding which the audio decoding unit 314 can process audio data.

The video decoding unit 316 decodes video data input from the demultiplexing unit 313 by a decoding format corresponding to the encoding format used for encoding (e.g., HEVC), and generates the original video data. The decoded video data is data indicating signal values making up video (frame images) at each point in time. The video decoding unit 316 outputs the decoded video data to the GUI compositing unit 317.

The GUI (Graphical User Interface) compositing unit 317 composites the video data input form the video decoding unit 316 and various types of GUI screen data input from the control unit 331, and generates video data indicating a display video. The GUI screen data includes selection screen data for selection of a broadcast channel, electronic program guide (EPG) data, and so forth.

The display unit 318 reproduces video based on the video data input from the GUI compositing unit 317. Accordingly, a GUI screen is displayed on the display unit 318, superimposed on the video relating to the video data that has been received. The display unit 318 is configured including a display, for example.

The storage unit 322 stores various types of data. The storage unit 322 is configured including a storage medium, for example, an HDD (Hard-disk Drive), flash memory, ROM (Read-only Memory), RAM (Random Access Memory), or a combination thereof. The operation input unit 323 obtains operating signals generated by accepting operation input from a user, and outputs the obtained operating signals to the control unit 331. Operating signals include, for example, signals indicating on/off of a power source and signals indicating a broadcast wave channel. Examples of the operation input unit 323 include an operating button, remote controller, an input interface that receives operating signals from an electronic device such as a mobile terminal device or the like, and so forth.

The control unit 331 controls various types of operations of the reception device 31. For example, the control unit 331 detects the presence of simulcast audio where audio data of multiple reproduction formats is provided in one program, from the configuration information input from the demultiplexing unit 313. In a case of having detected the presence of simulcast audio, the control unit 331 also selects the highest-order that is a reproduction format that can be processed at the audio decoding unit 314, out of the multiple reproduction formats. The control unit 331 outputs a format selection signal indicating the selected reproduction format. Note that the control unit 331 generates various types of GUI screen data based on operating signals input from the operation input unit 323, and outputs the generated GUI screen data to the GUI compositing unit 317.

### Configuration of Control Unit

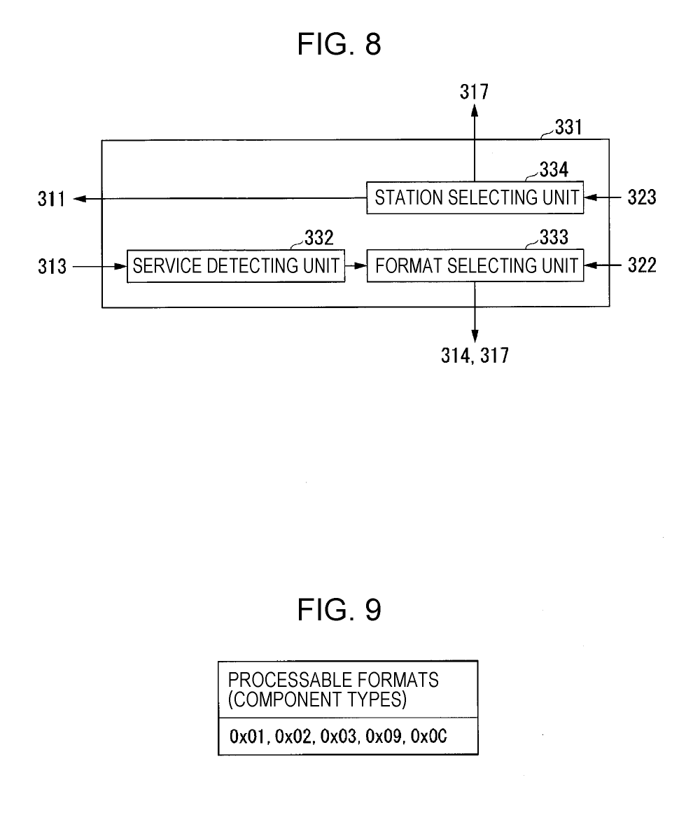

Next, the configuration of the control unit 331 according to the present embodiment will be described. FIG. 8 is a block diagram illustrating the configuration of the control unit 331 according to the present embodiment. The control unit 331 is configured including a service detecting unit 332, a format selecting unit 333, and a station selecting unit 334.

The service detecting unit 332 detects an MPT from the configuration information input from the demultiplexing unit 313, and determines whether or not simulcast audio is provided, based on the detected MPT. At this time, the service detecting unit 332 references the MH-audio component descriptor (MH-Audio_Component_Descriptor( )) described in the MPT descriptor region. (MPT_descriptors_byte) of the MPT, for each asset relating to audio data. In a case where a No. described in the simulcast group identification (simulcast_group_tag) included in the MH-audio component descriptor (MH-Audio Component Descriptor( )) is a No. other than the predetermined No. ‘0xFF’, The service detecting unit 332 determines that simulcast audio is provided. The simulcast group identification (simulcast_group_tag) is an identifier indicating the presence or absence of audio data that is of the same content as this audio data but encoded by a different format, i.e., indicating the presence or absence of simulcast audio. In a case where the No. described in the simulcast group identification (simulcast_group_tag) is the predetermined No. ‘0xFF’, the service detecting unit 332 determines that simulcast audio is not provided.

In a case of having determined that simulcast audio is provided, the service detecting unit 332 identifies MH-audio component descriptors (MH-Audio_Component_Descriptor( )) where a common No. other than the predetermined No. ‘0xFF’ is described in the simulcast group identification (simulcast_group_tag). The service detecting unit 332 reads the values described in each of the component type (component_type), component tag (component_tag), and main component flag (main_component_tag), of each of the identified MH-audio component descriptors (MH-Audio Component Descriptor( )). The service detecting unit 332 identifies, for each stream of audio data identified by a component tag based on the read values, the reproduction format, and whether or not the main signal. The service detecting unit 332 outputs service information indicating the reproduction format for each stream to the format selecting unit 333. The service detecting unit 332 outputs main signal information indicating the stream relating to the main signal to the audio decoding unit 314.

The format selecting unit 333 selects one reproduction format that the audio decoding unit 314 has processing capabilities, out of the reproduction formats for each stream indicated by the service information input from the service detecting unit 332, for example, the highest order reproduction format. Specifically, the format selecting unit 333 references an audio reproduction format table stored in the storage unit 322 beforehand, and identifies a reproduction format indicated by the audio reproduction format table, out of the reproduction formats indicated in the service information. The audio reproduction format table is data indicating reproduction formats regarding which the audio decoding unit 314 has processing capabilities. The format selecting unit 333 selects the highest order reproduction format out of the identified reproduction formats. “High order” means that high processing capabilities are required, e.g., that the number of audio channels is great. Generally, the higher the order of the reproduction format for the audio data is, the greater the amount of data is, so the higher the reproducibility of the original sound is. For example, the greater the number of audio channels is, the more accurately various spatial environments expressed by original sounds can be reproduced. The format selecting unit 333 generates format selection information indicating the selected reproduction format, and outputs the generated format selection information to the audio decoding unit 314. Accordingly, the audio decoding unit 314 outputs audio data decoded by the reproduction format that the format selecting unit 333 has selected to the amplifying unit 315.

The station selecting unit 334 selects a broadcast channel specified by an operating signal input from the operation input unit 323, and outputs a broadcast channel signal indicating the selected broadcast channel to the reception unit 311. Accordingly, the station selecting unit 334 can cause the reception unit 311 to receive broadcast waves of a channel band corresponding to the selected broadcast channel. The storage unit 322 also stores selection screen data beforehand, for selecting a broadcast channel. The station selecting unit 334 reads the selection screen data, and outputs the read selection screen data to the GUI compositing unit 317. Note that the station selecting unit 334 may output text data indicating the selected broadcast channel to the GUI compositing unit 317.

### Example of Audio Reproduction Format Table

Next, an example of the audio reproduction format table that the format selecting unit 333 references will be described.

FIG. 9 is a diagram illustrating an example of the audio reproduction format table. The audio reproduction format table is data representing Nos. of component types indicating reproduction formats regarding which the audio decoding unit 314 has processing capabilities. In the example illustrated in FIG. 9, the audio reproduction format table indicates, as component types, ‘0x01’, ‘0x02’, ‘0x03’, ‘0x09’, and ‘0x0C’. This indicates that the audio decoding unit 314 is capable of processing any of single monaural 1 ch, dual monaural 1 ch×2, stereo 2 ch, surround 5.1 ch, and surround 7.1 ch, as the reproduction format.

### Reception Processing

Next, reception processing according to the present embodiment will be described.

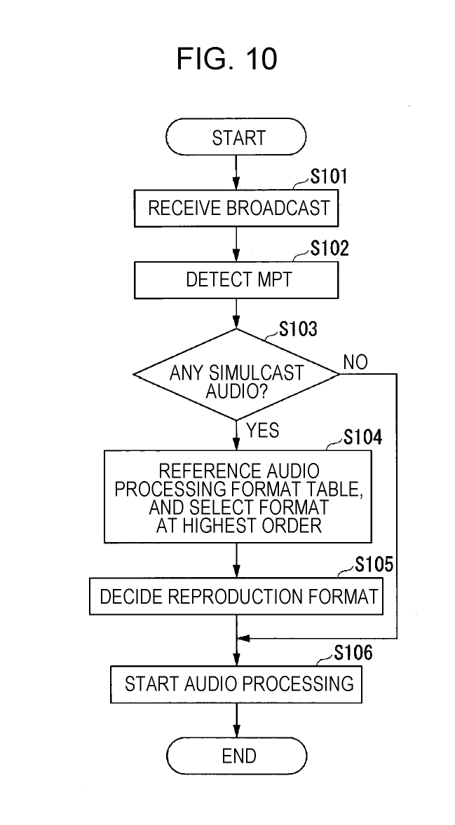

FIG. 10 is a flowchart illustrating reception processing according to the present embodiment.

(Step S101) The reception unit 311 receives broadcast waves that the transmission device 11 has transmitted, and demodulates the received broadcast waves. The decryption unit 312 decrypts encrypted multiplexed data obtained by the demodulating. The demultiplexing unit 313 divides the multiplexed data obtained by the decrypting into program data and configuration data. Subsequently, the flow advances to step S102.

(Step S102) The service detecting unit 332 detects an MPT from the configuration information that has been divided, and determines whether or not the audio of multiple reproduction formats (simulcast audio) is in the program to be broadcast, by analyzing the detected MPT. Subsequently, the flow advances to step S103.

(Step S103) In a case where determination is made that there is simulcast audio (YES in step S103), the flow advances to step S104. In a case where determination is made that there is no simulcast audio (NO in step S103), the flow advances to step S106. In this case, audio data of one reproduction format that has been identified by analyzing the MPT is the object of decoding processing.

(Step S104) The format selecting unit 333 references the audio reproduction format table stored in the storage unit 322 beforehand, identifies reproduction formats regarding which the audio decoding unit 314 has processing capabilities out of the reproduction formats identified by analyzing the MPT, and selects the highest order of the identified reproduction formats. Subsequently, the flow, advances to step S105.

(Step S105) The format selecting unit 333 decides to decode the audio data by the reproduction format that has been selected, and outputs format selection information indicating this reproduction format to the audio decoding unit 314. Subsequently, the flow advances to step S106.

(Step S106) The audio decoding unit 314 starts decoding processing based on audio data encoded using the reproduction format instructed by the format selection information input from the format selecting unit 333. Subsequently, the processing illustrated in FIG. 10 ends.

### Determination of Reproduction Format

Next, reproduction format determination processing regarding audio data included in the received program data will be described. The reproduction format determination processing below is performed at the time of determining the absence or presence of simulcast audio in step S102.

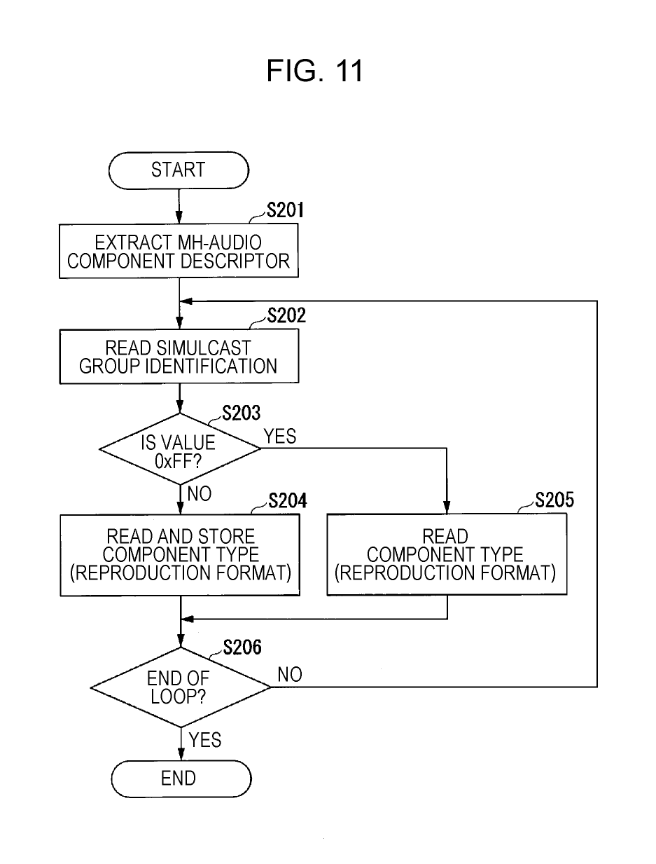

FIG. 11 is a flowchart illustrating the reproduction. format determination processing according to the present embodiment.

(Step S201) The service detecting unit 332 extracts the MH-audio component descriptor (MH-Audio_Component_Descriptor( )) from the MPT descriptor region (MPT_descriptors_byte) of the MPT that has been detected. Subsequently, the flow advances to step S202.

(Step S202) The service detecting unit 332 reads the No. described in the simulcast group identification (simulcast_group_tag), from the extracted MH-audio component descriptor (MH-Audio_Component_Descriptor( )). Subsequently, the flow advances to step S203.

(Step S203) The service detecting unit 332 determines whether or not the value that has been read is the predetermined value ‘0xFF’. In a case of having determined that the values is ‘0xFF’ (YES in step S203), determination is made that simulcast audio is not provided regarding the asset that is the object of processing regarding the audio data, and the flow advances to step S205. In a case of having determined that the values is not ‘0xFF’ (NO in step S203), determination is made that simulcast audio is provided regarding the asset that is the object of processing (audio data), and the flow advances to step S204.

(step S204) The service detecting unit 332 reads the component type (component_type) and component tag (component_tag) from the MS-audio component descriptor (MH-Audio Component_Descriptor( )) with regard to the asset that is the object of processing. The service detecting unit 332 stores (stores) the component type (component_type) and component tag (component_tag) that have been read in the storage unit 322 in a correlated manner. Thus, the reproduction format is identified for each asset regarding the simulcast audio. Subsequently, the flow advances to step S205.

(Step S205) The service detecting unit 332 reads the component type (component_type) from the MH-audio component descriptor (MH-Audio_Component_Descriptor( )) that is the object of processing. Accordingly, the reproduction format in a case where simulcast audio is not provided is identified. Subsequently, the flow advances to step S206.

(Step S206) The service detecting unit 332 determines whether or not the asset to be processed is the last in a loop regarding assets described in the MPT. In a case where determination is made to be the last in the loop (YES in step S206), the processing illustrated in FIG. 11 is ended. In a case where determination is made not to be the last in the loop (NO in step S206), the asset to be processed is changed to a next unprocessed asset, and the flow advances to step S202. Accordingly, whether or not simulcast audio is provided for the received program data is determined. In a case where simulcast audio is provided, multiple reproduction formats regarding the provision are identified. In a case where simulcast audio is not provided, the reproduction format of the one audio data that has been received is identified.

As described above, the reception device 31 according to the present embodiment has the service detecting unit 332 that detects the presence of audio data of multiple reproduction formats in one program, from configuration information received from the transmission device 11, and the audio decoding unit 314 that decodes audio data received from the transmission device 11.

The reception device 31 also includes the format selecting unit 333 that selects reproduction formats that the audio decoding unit 314 is capable of decoding, out of multiple reproduction formats.

According to this configuration, the reception device 31 can reproduce audio based on audio data of one of the formats, out of the audio data of multiple reproduction formats that has been received. Accordingly, the reception device 31 can reproduce audio intended by the program producer, without involving deterioration of quality due to compositing processing.

The format selecting unit 333 in the reception device 31 according to the present embodiment further selects, from the reproduction formats that the audio decoding unit 314 is capable of decoding, the reproduction format which needs the highest processing capabilities.

According to this configuration, the reception device 31 can reproduce audio based on audio data of a format that is decodable and needs the highest processing capabilities, out of audio data of multiple reproduction formats received. Accordingly, the user can receive audio service with the highest reproducibility of the original sound for the audio service that the program producer intended.

### Second Embodiment

Next, a second embodiment of the present invention will be described. Configurations that are the same as the above-described are denoted with the same reference numerals, and description will be included by reference.

The reception device 31 has a service detecting unit 332a (omitted from illustration) instead of the service detecting unit 332. The service detecting unit 332a determines whether or not a multi-view service is provided, using an MH-event information. table (MH-EIT: MH-Event Information Table), instead of the MPT.

An MH-EIT is one of configuration elements in the configuration information received from the transmission device 11, and represents information relating to the program, such as the title of the program to be broadcast, the date and time of broadcast, and so forth. In the present embodiment, the configuration information generating unit 112 of the transmission device 11 generates an MH-EIT where an MH-audio component descriptor (MH-Audio_Component_Descriptor( )) is described in a descriptor region (descriptor( )) for a program (event) providing multi-view service. The configuration information generating unit 112 outputs configuration information including the generated MH-EIT to the multiplexing unit 113.

The service detecting unit 332a then determines whether or not the MH-audio component descriptor (MH-Audio_Component_Descriptor( )) is described in the descriptor region (descriptor( )) of the MH-EIT. In a case where this descriptor is described, the service detecting unit 332a references this descriptor (MH-Audio_Component_Descriptor( )) and determines whether or not simulcast audio is provided, in the same way as the service detecting unit 332. In a case of having determined that simulcast audio is provided, MH-audio component descriptors (MH-Audio_Component_Descriptor( )) where a common No. is described in the simulcast group identification (simulcast_group_tag) is identified. The service detecting unit 332a references the identified MH-audio component descriptors (MH-Audio_Component_Descriptor( )) and identifies the reproduction format and whether or not the main signal, for each stream of audio data identified by the component tag. The service detecting unit 332a outputs service information indicating the reproduction format for each steam to the format selecting unit 333. The service detecting unit 332a outputs main signal information indicating a stream relating to the main signal to the audio decoding unit 314.

Note that the MH-EIT to be processed may be an MH-EIT of a program being broadcast at that point in time, or may be an MH-EIT that is the object of programming for reception.

### Data Structure of MH-EIT

Next, an example of an MH-EIT included in the configuration information will be described.

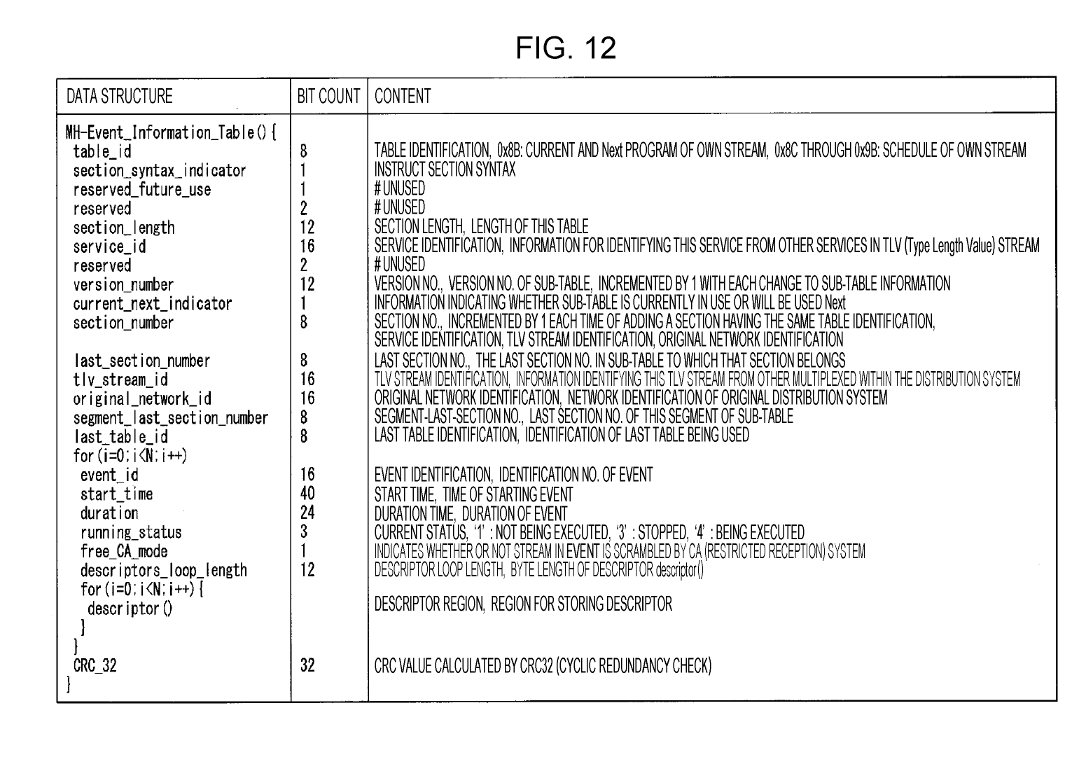

FIG. 12 is a diagram illustrating an example of an MH-EIT. In the example illustrated in FIG. 12, the MH-EIT includes, for each event (program), event identification (event_id), start time (start_time), duration time (duration), and descriptor region (descriptor( )). Described in event identification (event_id) is identification Nos. of individual events. Described in start time (start_time) and duration time (duration) are the start time and duration time of that event (program). Accordingly, by reading these information, the format selecting unit 333 can tell the start time and end time of the program, and determine the state of broadcast (before broadcast, during broadcast, after broadcast). The descriptor region (descriptor( )) is a region where the above-described MH-audio component descriptor (MH-Audio_Component_Descriptor( )) is described. Multiple descriptor regions (descriptor( )) can be described for each event. That is to say, there are cases where multiple MH-audio component descriptors (MH-Audio_Component_Descriptor( )) specifying reproduction formats of audio data are described, for example, for each of multiple streams (equivalent to assets) of audio data.

### Reception Processing

Next, reception processing relating to the present. embodiment will be described.

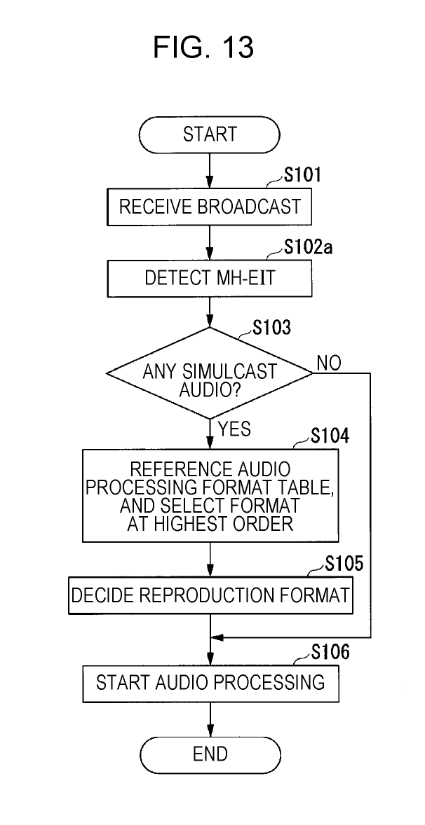

FIG. 13 is a flowchart illustrating reception processing according to the present embodiment. The reception processing in the present embodiment includes steps S101, S102a, and S103 through S106. Steps 101 and S103 through S106 are the same as those illustrated in FIG. 10, so description will be included by reference.

In the processing illustrated in FIG. 13, after the processing of step S101 has ended, the flow advances to step S102a.

(Step S102a) The service detecting unit 332a detects an MH-EIT from the divided configuration information, and determines whether or not audio of multiple reproduction formats (simulcast audio) is in the program to be broadcast, by analyzing the detected MH-EIT. Note that in the analysis of the MH-EIT, the service detecting unit 332a performs reproduction format determination processing (FIG. 11) regarding the MH-EIT, instead of the MPT. Subsequently, the flow advances to step S103.

As described above, the reception device 31 according to the present embodiment has the service detecting unit 332a that detects the presence of audio data of multiple reproduction formats in one program, from the MH-EIT out of the configuration information received from the transmission device 11, and the audio decoding unit 314 that decodes the audio data received from the transmission device 11. The reception device 31 also has the format selecting unit 333 that selects, out of multiple reproduction formats, reproduction formats that the audio decoding unit 314 is capable of decoding with.

According to this configuration, the reception device 31 can reproduce audio based on audio data of one of the formats, out of the audio data of multiple reproduction formats that has been received. Accordingly, the reception device 31 can reproduce audio intended by the program producer, without involving deterioration of quality due to compositing processing. Also, the presence of simulcast audio providing audio data of multiple reproduction formats for one program can be efficiently detected in increments of programs from the MH-EIT.

### Third Embodiment

Next, a third embodiment of the present invention will be described. Configurations that are the same as the above-described are denoted with the same reference numerals, and description will be included by reference.

The format selecting unit 333 of the reception device 31 according to the above-described embodiments has been described as selecting audio data of a reproduction format of which the reproducibility is the highest out of audio data of multiple reproduction formats received, so the reproduction format desired by the user is not necessarily selected. In the present embodiment, the user is enabled to select audio data of a desired format, out of audio data of multiple reproduction formats included in program data being broadcast.

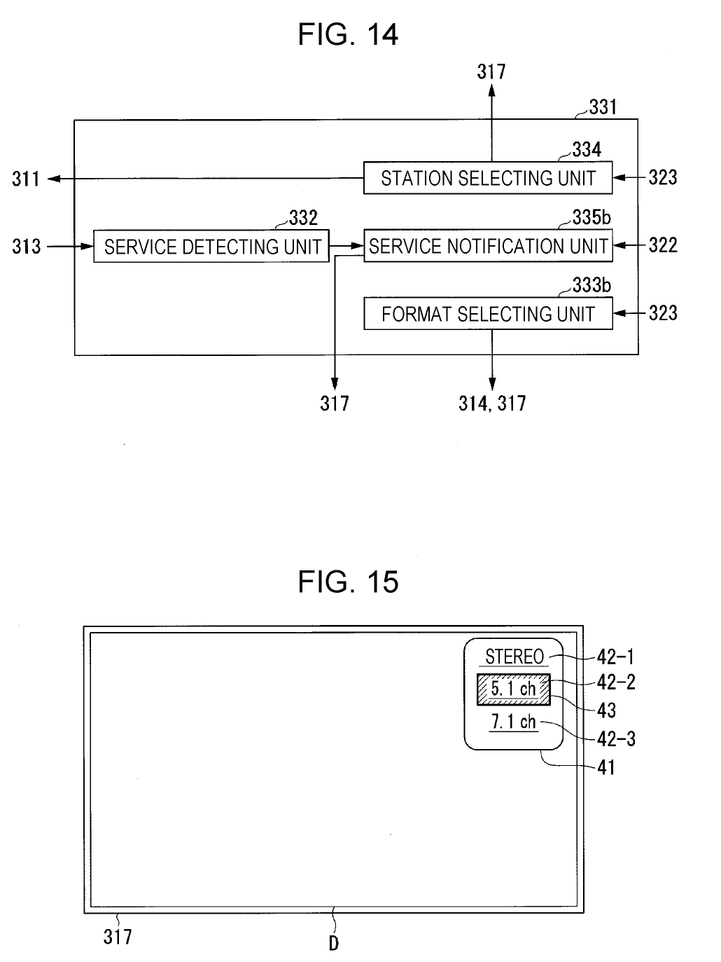

FIG. 14 is a block diagram illustrating the configuration of the control unit 331 according to the present embodiment. The control unit 331 of the reception device 31 according to the present embodiment has a format selecting unit 333b instated of the format selecting unit 333, and further has a service notification unit 335b.

In the same way as the format selecting unit 333, the format selecting unit 333b references an audio reproduction format table stored in the storage unit 322 beforehand, and out of the reproduction formats indicated by service information input from the service detecting unit 332, selects reproduction formats regarding which the audio decoding unit 314 has processing capabilities.

On the other hand, when an operating signal indicating one of the identified reproduction formats is input form the operation input, unit 323, the format selecting unit 333b selects the reproduction format based on the input operating signal. The format selecting unit 333b generates format selection information indicating the selected reproduction format, and outputs the generated format selection information to the audio decoding unit 314.

The service notification unit 335b reads format selection button data, indicating a format selection button for selection of reproduction format by operating, from the storage unit 322. The format selection button data is stored in the storage unit 322 beforehand. The service notification unit 335b overlays text, indicating a reproduction format identified by the format selecting unit 333b based on the service information, on a format selection button, and outputs notification information indicating the format selection button on which this text has been overlaid to the GUI compositing unit 317. Thus, the format selection button is displayed on the display unit 318. Note that in a case where a predetermined amount of time (e.g., one minute) elapses from the start of display of the format selection button without input of an operating signal from the operation input unit 323, the service notification unit 335b stops output of the notification information. Accordingly, the display period of the format selection button is restricted, thereby avoiding preventing the user from watching the program.

### Format Selection Button

Next, an example of the format selection button for the format selecting unit 335b to display on the display unit 318 will be shown.

FIG. 15 is a diagram illustrating an example of a format selection button (format selection button 41) according to the present embodiment. The example illustrated in FIG. 15 is an example of the reception device 31 that is capable of processing audio data of three reproduction formats (stereo 2 ch, surround 5.1 ch, surround 7.1 ch) having received audio data of four reproduction formats (stereo 2 ch, surround 5.1 ch, surround 7.1 ch, surround 22.2 ch) from the transmission device 11.

The format selection button 41 is a button displayed at a position closer to one apex (upper right edge) of a display screen D on the display unit 318 than the center portion. By displaying the format selection button 41 at this position, viewing of the program by the user is not impeded.

The text 42-1 of “stereo”, the text 42-2 of “5.1 ch”, and the text 42-3 of “7.1 ch”, applied to the format selection button 41, are displays respectively indicating that stereo 2 ch, surround 5.1 ch, and surround 7.1 ch are available as reproduction formats.

In the example illustrated in FIG. 15, operation can be made as to these displays by the operation input unit 323. For example, the format selecting unit 333b selects a reproduction format relating to one of the texts 42-1 through 42-3, displayed in a display region including a position indicated by an operating signal input form the operation input unit 323. A hatched portion 43 displayed overlaid on the text 42-2 is a display indicating that surround 5.1 ch is selected as a reproduction format relating to the text 42-2. Accordingly, the user can select audio of a desired reproduction format out of the reproduction formats that the reception device 31 is capable of processing. Note that in a case where no operating signal is input to the format selecting unit 333b, a processable reproduction format set beforehand, i.e., a reproduction format specified as the main audio in a MH-audio component descriptor (MH-Audio_Component_Descriptor( )), may be selected.

### Reception Processing

Next, reception processing according to the present embodiment will be described.

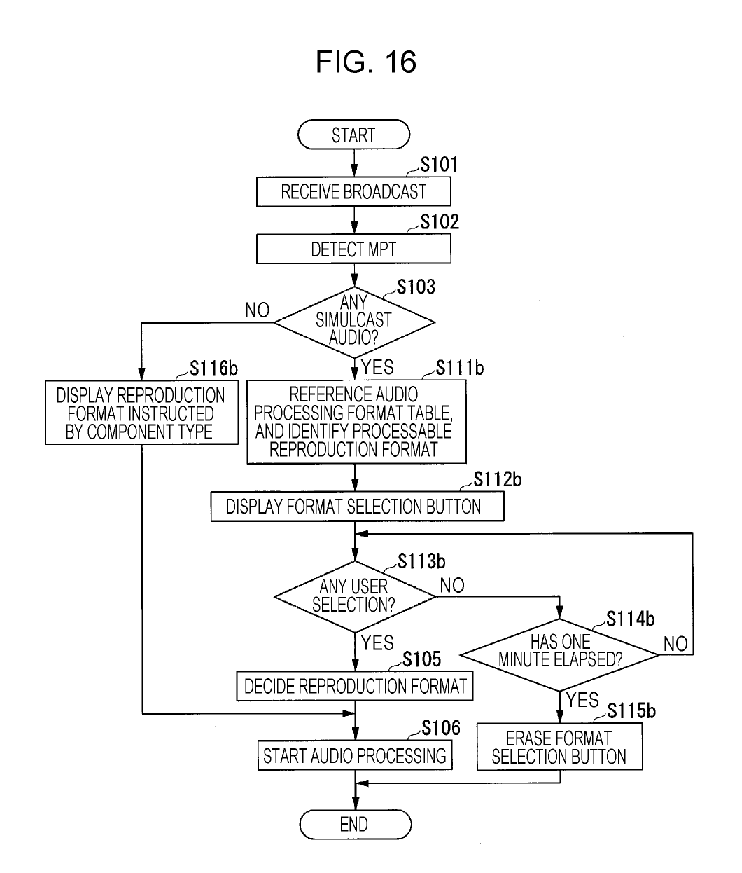

FIG. 16 is a flowchart illustrating reception processing according to the present embodiment. The reception processing in the present embodiment includes steps S101 through S103, S105, S106, and S111b through S116b. Steps 101 through S103, S105, and S106 are the same as those illustrated in FIG. 10, so description will be included by reference.

In the processing illustrated in FIG. 16, in a case where determination is made in step S103 that there is simulcast audio (YES in step S103), the flow advances to step S111b. In a case where determination is made that there is no simulcast audio (NO in step S103), the flow advances to step S116b.

(Step S111b) the format selecting unit 333b references the audio reproduction format table stored in the storage unit 322 beforehand, and identifies, of the reproduction formats indicated by the service information input from the service detecting unit 332, the reproduction formats that the audio decoding unit 314 is capable of processing. Subsequently, the flow advances to step S112b.

(step S112b) The service notification unit 335b reads the format selection button. data from the storage unit 322, and outputs notification information indicating the format selection button where text indicating the identified reproduction formats has been overlaid on the format selection button to the GUI compositing unit 317. Thus, the format selection button is displayed on the display unit 318. Subsequently, the flow advances to step S113b.

(Step S113b) The format selecting unit 333b determines whether or not an operating signal indicating one of the identified reproduction formats has been input from the operation input unit 323. Determination is made regarding whether or not there has been selection of reproduction format by the user. In a case of determining that there has been input (YES in step S113b), the reproduction format is selected based on the input operating signal. Subsequently, the flow advances to step S105. In a case where determination is made that there has been no input (NO in step S113b), the flow advances to step S114b.

(Step S114b) The format selecting unit 333b determines whether or not a predetermined amount of time (e.g., one minute) has elapsed from start of display of the format selection button. If determination is made to have elapsed (YES in step S114b), the format selecting unit 333b selects the above-described main audio as the default reproduction format, and the flow advances to step S115b. In a case where determination is made not to have elapsed (NO in step S114b), the flow advances to step S113b.

(Step S116b) The service notification unit 335b stops output of notification information. Accordingly, the format selection button is deleted. Subsequently, the processing illustrated in FIG. 16 is ended.

(Step S116b) The service notification unit 335b outputs notification information indicating the one reproduction format identified by analyzing the MPT, i.e., the reproduction format instructed by the component type (component_type) described in the MH-audio component descriptor (MH-Audio_Component_Descriptor( )), to the GUI compositing unit 317. Accordingly, the instructed reproduction format is displayed. Subsequently, the processing illustrated in FIG. 16 is ended.

As described above, the reception device 31 according to the present embodiment has the service notification unit 35b that outputs notification information indicating reproduction formats processable by the audio decoding unit 314, out of multiple reproduction formats, and the format selecting unit 333b selects one of the reproduction formats represented by a format selection button by notification information in accordance with an operating input.

According to this configuration, the reception device 31 can reproduce audio, out of the audio data of multiple reproduction formats that has been received, that is reproducible and that has been selected in accordance with operating input. Accordingly, the user can select, of audio services intended by the program producer, a desired reproducible audio service.

The reception device 31 according to the present embodiment also includes the station selecting unit 334 that selects a broadcast channel from which to receive broadcast waves, in accordance with operating input. The service detecting unit 332 further extracts, from the MPT included in received multiplexed data, an identifier indicating the presence or absence of audio data that is of the same content as the audio data making up the program but encoded by a different format. The service detecting unit 332 also detects the presence of audio data of multiple formats, based on the extracted identifier.

According to this configuration, audio based on audio data of a format preferred by the user can be reproduced from audio data making up the program received on the selected broadcast channel.

### Fourth Embodiment

Next, a fourth embodiment of the present invention will be described. Configurations that are the same as the above-described are denoted with the same reference numerals, and description will be included by reference.

In the present embodiment, having the configuration described next enables the user to select audio data of a desired format from audio data of multiple reproduction formats which will be broadcast in a program to be received at the programmed time of reception. Reception programming may be either programming for recording or programing for viewing.

The configuration information generating unit 112 of the transmission device 11 here generates the above-described MH-EIT and an MH-service description table (MH-SDT: MH-Service Description Table) as information indicating an electronic program guide indicating planned broadcasting of programs. An MH-SDT is information relating to program channels, such as names of program channels (i.e., individual broadcast channels), names of broadcasters, and so forth. The configuration information generating unit 112 outputs configuration information including the generated MH-EIT and MH-SDT to the multiplexing unit 113. The reception device 31 receives the MH-EIT and MH-SDT from the transmission device 11, and generates EPG data based on the received MH-EIT and MH-SDT, which will be described below.

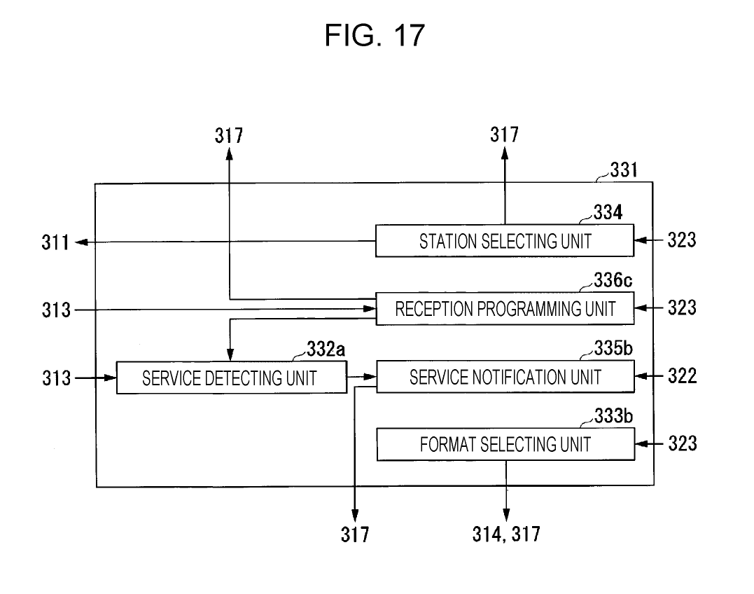

FIG. 17 is a block diagram illustrating the configuration of the control unit 331 according to the present embodiment. The control unit 331 of the reception device 31 according to the present embodiment includes the service detecting unit 332a, format selecting unit 333b, station selecting unit 334, and service notification unit 335b, and further includes a reception programming unit 336c.

The reception programming unit 336c extracts the MH-SDT and MH-EIT from the configuration information input from the demultiplexing unit 313, and identifies broadcast times of individual programs indicated by the MH-EIT, for each of the broadcast channels indicated by the extracted MH-SDT. The reception programming unit 336c configures an EPG by arraying the broadcast channels and broadcast times identified for each program, in the order of which the broadcast time is earlier, for each broadcast channel. The reception programming unit 336c generates EPG data indicating the configured EPG, and outputs the generated EPG data to the GUI compositing unit 317. Thus, the EPG is displayed on the display unit 318.

The reception programming unit 336c selects programs relating to reception programming, based on operating signals input from the operation input unit 323. The reception programming unit 336c selects, for example, a program regarding which the position indicated by an operating signal is included in a display region on the EPG. The reception programming unit 336c outputs program information indicating the selected program to the service detecting unit 332a.

The service detecting unit 332a analyzes the MH-EIT relating to the program indicated by the program information input from the reception programming unit 336c, and determines whether or not there is audio of multiple reproduction formats in this program.

In a case where determination is made that there is audio data of multiple reproduction formats, the service notification unit 335b displays on the display unit 318 a format selection button indicating the reproduction formats processable by the audio decoding unit 314 out of the multiple reproduction formats. The format selecting unit 333b selects one of the reproduction formats displayed in the format selection button based on an operation signal input from the operation input unit 323. The format selecting unit 333b outputs format selection information indicating the selected reproduction format to the audio decoding unit 314.

Note that operating signals instructing reception start time and reception end time as the reception time of this program are input to the reception programing unit 336c from the operation input unit 323. The reception programming unit 336c outputs the reception start signal instructing start of reception, at the reception start time, to the audio decoding unit 314 and the video decoding unit 316. The reception programming unit 336c outputs the reception end signal instructing end of reception, at the reception end time, to the audio decoding unit 314 and the video decoding unit 316.

Accordingly, at the reception time instructed by the operating input, the audio decoding unit 314 performs decoding processing of audio data using the selected reproduction format, and the video decoding unit 316 performs decoding processing of the video data.

### Reception Processing

Next, the reception processing according to the present embodiment will be described.

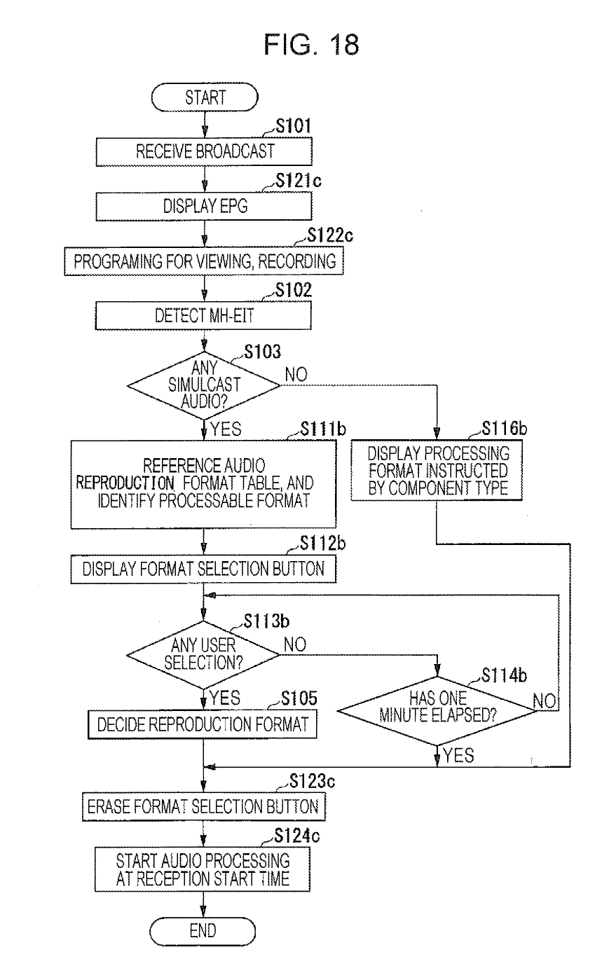

FIG. 18 is a flowchart illustrating reception processing according to the present embodiment. The reception processing in the present embodiment includes steps S101 through S103, S105, S111b through S114b, S116b, and S121c through S124c. Steps 101 through S103 and S105 are the same as those illustrated in FIG. 10, and the processing of steps S111b through S114b and S116b are the same as those illustrated in FIG. 16, so description will be included by reference.

After step S101 in the processing illustrated in FIG. 18, the flow advances to step S121c.

(Step S121c) The reception programming unit 336c identifies broadcasting times of individual programs indicated by the EIT, for each broadcast channel indicated by the MH-SDR, extracted from the configuration information. The reception programming unit 336c generates EPG data where broadcast channels and identified broadcast times for each program have been arrayed in order of broadcast time, for each broadcast channel. The reception programming unit 336c outputs the generated EPG data to the GUI compositing unit 317, thereby displaying the EPG on the display unit 318. Subsequently, the flow advances to step S122c.

(Step S122c) The reception programming unit 336c selects, out of programs indicated by the EPG, a program relating to reception programming, i.e., to programming for viewing or recording, based on operating signals input from the operation input unit 323. Subsequently, the flow advances to step S102. The MH-EIT relating to the selected program is analyzed in step 3102.

In a case where step S105 or S116b has ended, or determination is made in step S114b that a predetermined amount of time has elapsed (YES in step S114b), the flow advances to step S123c. At this stage, the reproduction format has been decided by the format selecting unit 333b.

(Step S123c) The service notification unit 335b erases the format selection button that had been displayed on the display unit 318. Subsequently, the flow advances to step S124c.

(step S124c) The audio decoding unit 314 starts decoding processing of audio data using the reproduction format selected by the format selecting unit 333b, at the reception start time instructed by the reception programing unit 336c. Subsequently, the processing illustrated in FIG. 18 is ended.

Although a case where programming for viewing has been instructed as programming for reception above, in a case where programming for recording is instructed, the storage unit 322 stores program information indicating the program, audio data that the audio decoding unit 314 has decoded, and video data that the video decoding unit 316 has decoded, in a correlated manner. At this time, the audio decoding unit 314 does not have to output the decoded audio data to the amplifying unit 315, and the video decoding unit 316 does not have to output the decoding video data to the GUI compositing unit 317.

As described above, the reception device 31 according to the present embodiment has the reception programming unit 336c that perform programming for reception of one of the programs regarding which broadcasting is planned, in accordance with operating input. The service detecting unit 332a extracts program information including broadcast time of each program regarding which programming is planned from the received MH-EIT, and an identifier indicating presence or absence of audio data of the same content as the audio data making up the program but encoded. by a different format. The service detecting unit 332a also detects the presents of audio data of multiple formats in program data regarding which the reception programming unit 336c has programmed reception, based on the identifier.

According to this configuration, out of the audio data of multiple formats that will be received in the selected program, audio data of one format can be stored or the audio can be reproduced. Accordingly, with regard to programs that will be broadcast with the selected program, audio data of a preferred format, out of audio data regarding audio intended by the program producer, can be recorded or the audio thereof can be reproduced, without involving deterioration of quality due to audio compositing processing.

### Fifth Embodiment

Next, a fifth embodiment of the present invention will be described. Configurations that are the same as the above-described are denoted with the same reference numerals, and description will be included by reference.

In the present embodiment, a display indicating audio data of multiple reproduction formats and language sets is displayed on the display unit 318 such that a predetermined language has priority over other languages, by having the configuration that will be described next.

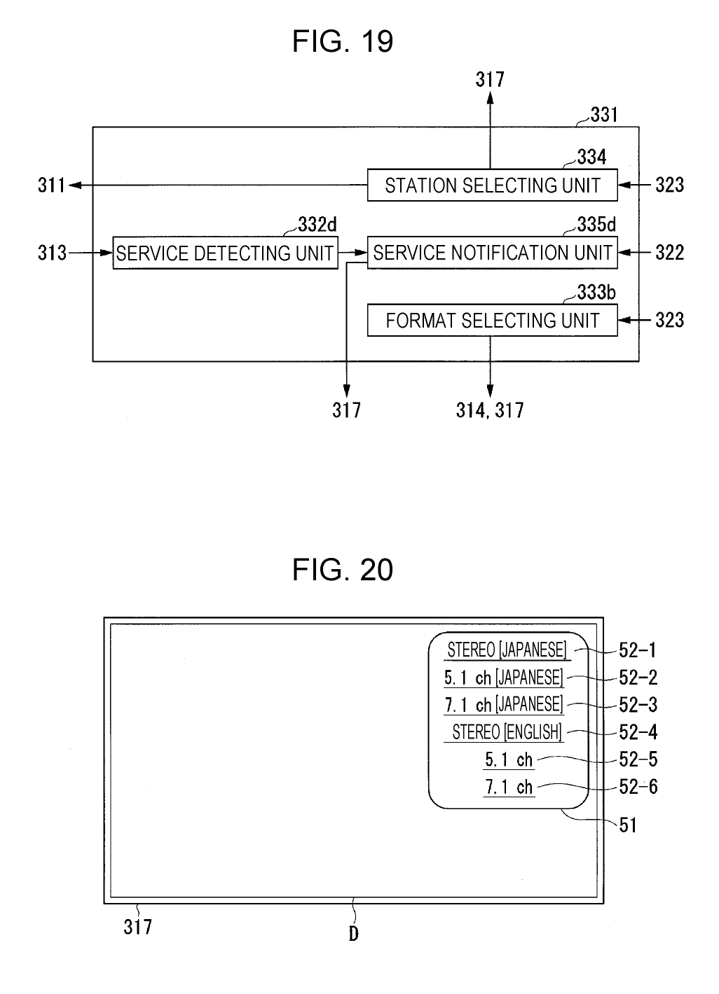

FIG. 19 is a block diagram illustrating the configuration of the control unit 331 according to the present embodiment. The control unit 331 of the reception device 31 according to the present embodiment includes a service detecting unit 332d, the format selecting unit 333b, the station selecting unit 334, and a service notification unit 335d. The storage unit 322 (FIG. 7) stores priority language data, indicating the correlation between priority and language, beforehand. Priority means, in a case where there are multiple languages representing the audio of the same content making up the program, to display a display regarding that audio data with priority over other languages or not, or an order of priority among the languages. For example, the storage unit 322 stores priority language data indicating the Japanese is to be given priority over other languages (English, Chinese, etc.). Language setting data indicating a language to be used for screen display for manifesting or adjusting functions of the reception device 31 may be used as priority language data.

The service detecting unit 332d determines whether or not simulcast audio is provided based on the MPT or MH-EIT, as described above, and identifies the reproduction format of each asset of the audio data. In the present embodiment, in a case where determination is made that simulcast audio is provided, the service detecting unit 332d identifies the language that represents that audio for each asset.

Specifically, the service detecting unit 332d reads a language code (ISO_639_Language_code) from the MH-audio component descriptor (MS-Audio_Component_Descriptor( )) described in the MPT or MH-EIT. The service detecting unit 332d then outputs service information, indicating the set of identified reproduction format and language for each asset, to the service notification unit 335d.

The service notification unit 335d identifies the set of reproduction format and language for each asset that the service information input from the service detecting unit 332d indicates. The service notification unit 335d changes the order of the identified set, in accordance with the priority of language indicated by the priority language data read from the storage unit 322. For example, in a case where the priority language data gives priority to Japanese over other languages, the service notification unit 335d puts a set including Japanese, out of the identified sets, before sets including other languages. The service notification unit 335d reads format selection button data from the storage unit 322. The service notification unit 335d arrays text indicating each set and overlays on the format selection button following the changed order. The service notification unit 335d outputs notification information indicating the format selection button on which the text has been overlaid to the GUI compositing unit 317, thereby displaying the format selection button indicated by this notification information on the display unit 318.

### Format Selection Button

Next, an example of a format selection button that the service notification unit 335d displays on the display unit 318 will be illustrated.

FIG. 20 is a diagram illustrating an example of a format selection button according to the present embodiment (format selection button 51). The format selection button 51 shows six sets 52-1 through 52-6, and it is shown that the sets 52-1 through 52-3 relating to Japanese have higher priority than sets 52-4 through 52-6 regarding which other languages are set, or no language is set. The set 52-1 is Japanese audio by stereo 2 ch, the set 52-2 is Japanese audio by surround 5.1 ch, the set 52-3 is Japanese audio by surround 7.1 ch, and the set 52-4 is English audio by stereo 2 ch. No language has been set for sets 52-5 and 52-6, with surround 5.1 ch and 7.1 ch having each been set as reproduction formats. Operations can be made by the display of sets 52-1 through 52-6 to select audio data regarding a relevant set, in the same way as the example illustrated in FIG. 15.

Thus, the reception device 31 places sets related to Japanese so as to be ordered before sets related to other languages and sets with no language specification. Accordingly, the user is prompted to select audio data for a set regarding Japanese.

Although a case has been described in the above example where priority is specified in two steps, in which Japanese that is one language is given higher propriety than other languages, this is not restrictive. An arrangement may be made where priority is specified in three or more steps with regard to multiple languages in priority language data, and the service notification unit 335d places text indicating sets of the reproduction format and language for each asset, in an order according to priority. With regard to sets with no language specification, the service notification unit 335d may place text indicating the set, with the same priority as the language of the highest priority. In a case where there are multiple reproduction formats for the same language, the service notification unit 335d may place text indicating the sets such that the higher order the reproduction format is, the higher priority is given.

Note that the service notification unit 335d may display in the display unit 318 such that the higher the priority of the set is, the higher the visibility is. In order to raise visibility, the service notification unit 335d may use text that is larger in size, or may highlight the contrast with background luminance.

### Sixth Embodiment

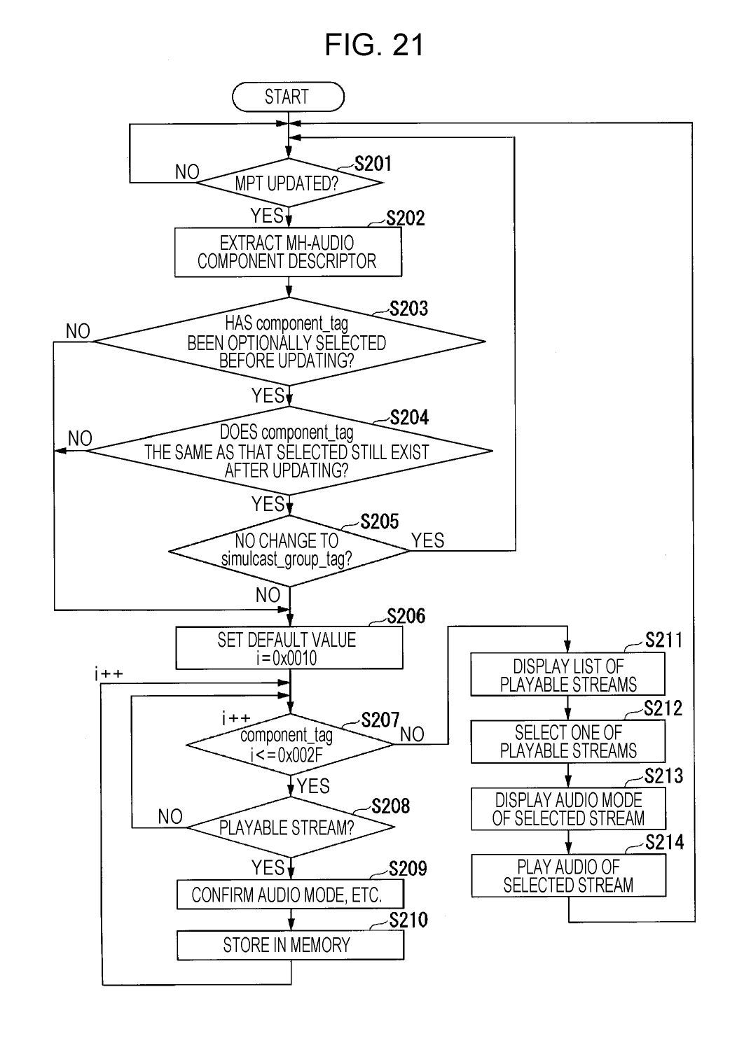

Next, a sixth embodiment of the present invention will be described. Configurations that are the same as the above-described are denoted with the same reference numerals, and description will be included by reference. The control unit 331 of the reception device 31 according to the present embodiment is configured including the service detecting unit 332, format selecting unit 333b, station selecting unit 334, and service notification unit 335b described in the third embodiment (see FIG. 14). Description will be made with reference to FIG. 21, primarily regarding points of difference as to the above-described embodiments.

FIG. 21 is a diagram illustrating an example of reception processing according to the present embodiment.

The service detecting unit 332 detects whether or not the MPT making up the configuration information input from the demultiplexing unit 313 has been updated, each time an MPT is detected (step S201). The service detecting unit 332 determines that the MPT has been updated where there is change from the previous time regarding at least one information making up the MPT, e.g., any one of version identification, length of this table, package ID, MPT descriptor length, number of assets, asset ID, and so forth, or any combination thereof. If there is no change in any of these information, the service detecting unit 332 determines that the MPT has not been updated. If determination is made that there has been no update (NO in step S201), the processing of step S201 is repeated. If determination is made that there has been an update (YES in step S201), the flow advances to the processing in step S202. Note that the MPT is updated when the broadcast channel where reception signals are received is changed by changing a station, or when programs that are the object of reception are changed due to elapse of time.

The service detecting unit 332 extracts the MH-audio component descriptor for each asset relating to audio data (audio asset), from the updated MPT (step S202). As described above, the MH-audio component descriptor indicates correlation information set corresponding to each of the audio assets provided in the program, and includes information such as the component tag (component_tag), simulcast group identification (simulcast_group_tag) component type (component_type), and so forth, as elements. Subsequently, the flow advances to the processing in step S203.

In a case where multiple audio data encoded in audio modes that the audio decoding unit 314 is capable of processing, provided in one program, as described above, the format selecting unit 333b selects one of these multiple. The format selecting unit 333b identifies the component tag (component_tag) correlated with the audio data specified by an operating signals input from the operation input unit 323, and stores information of the identified component tag in the storage unit 322. A component tag is information identifying an individual audio asset, and is described in the MH-audio component descriptor. In the present embodiment, information of the component tag stored in the storage unit 322 is referenced and determination is made regarding whether or not a component tag has been selected corresponding to audio data optionally specified, i.e., by an operating signal, before the MPT was updated (step S203). If determining that this was selected (YES in step S203), the flow advances to the processing in step S204. If determining that this was not selected (NO in step S203), the flow advances to the processing in step S206.

The format selecting unit 333b determines whether or not a component tag having the same value as that component tag still exists in the MPT after updating, as correlation information corresponding to the audio data selected before the MPT was updated (step S204). If determining that this exists (YES in step S204), the flow advances to the processing in step S205. If determining that this does not exist (NO in step S204), the flow advances to the processing in step S206.

The format selecting unit 333b determines whether or not there has been no change in the simulcast group identification (simulcast_group_tag) corresponding to the audio data selected before updating of the MPT, and the simulcast group identification corresponding to the audio data after updating of the MPT, of which the component tag value is the same (S205). The simulcast group identification is information that indicates the presence of audio data having the same content as that audio data, of which one or both of the audio mode and language differs. A common value is given for the simulcast group identification to a group of audio data having the same content. Accordingly, presence of absence of simulcast audio provided in a program, and change of one or both of the content of the simulcast audio, can be detected by change in the simulcast group identification. If determining that the simulcast group identification has not changed. (YES in step S205), the format selecting unit 333b selects audio data of which the value of the component tag is the same, and outputs the selected audio data and format selection information indicating the reproduction format to the audio decoding unit 314. Thus, the audio of the audio data selected out of the audio data from the demultiplexing unit 313 is decoded, and reproduced from the amplifying unit 315. Subsequently, the flow advances to step S201.

On the other hand, if determining that the simulcast group identification has changed (NO in step S205), the flow advances to the processing in step S206.

The service detecting unit 332 sets a predetermined minimum value i for a component tag value i correlated with each audio asset, as a default value (step S206). The minimum value of the component tag value i is, for example, 0x0010. Subsequently, the flow advances to step S207.

The service detecting unit 332 determines whether or not the component tag value i is a predetermined maximum value (e.g., 0x002F) or lower (step S207). If determining that the component tag value i is the maximum value or lower (YES in step S207), the flow advances to the processing in step S208. If determining that the component tag value i has exceeded the predetermined maximum value (NO in step S207), the flow advances to the processing in step S211.

The service detecting unit 332 identifies the audio mode that the component type (component_type) described in the MH-audio component descriptor including the component tag value i indicates. The service detecting unit 332 references the audio reproduction format table described above, and determines whether or not the identified audio mode is a reproduction format regarding which the audio decoding unit 314 has processing capabilities (step S208). That is to say, determination is made regarding whether or not the audio data relating to the component tag i is a reproducible stream. If determining to be reproducible (YES in step S208), the flow advances to the processing in step S209. If determining not to be reproducible (NO in step S208), the service detecting unit 332 increases (increments) the component tag value i by 1 to change the audio asset that is the object of processing. Thereafter, the flow returns to the processing in step S207.

The service detecting unit 332 confirms information serving as elements of notification information, such as the audio mode of the audio asset relating to that component tag value i (step S209). When audio mode information is included in information described in a component description (text_char) of the MH-audio component descriptor including the component tag value i, for example, the service detecting unit 332 employs the information described therein as the audio information. When there is no audio mode information included in the information described in the component description, text information indicating the audio mode that the component type indicates is employed as the audio information. Subsequently, the flow advances to the processing in step S210.

The service detecting unit 332 correlates the employed audio information and the component tag value i and stores in the storage unit 322 (memory) (step S210). Accordingly, a list of audio that the reception device 31 is capable of reproducing is compiled. Thereafter, the service detecting unit 332 increments the component tag value i by 1, thereby changing the audio asset that is the object of processing. Subsequently, the flow returns to the processing in step S207.

The service notification unit 335b outputs GUI screen data including all audio information read out from the storage unit 322 as notification information, to the display unit 318 via the GUI compositing unit 317 (step S211). Accordingly, a list of streams of reproducible audio data is displayed on the display unit 318. Subsequently, the flow advances to the processing in step S212.

The format selecting unit 333b selects audio data corresponding to one of the component tag values stored in the storage unit 322 (step S212). Now, in a case where an operating signal is input from the operation input unit 323, the format selecting unit 333b selects audio data specified by that operating signal, and stores the component tag value of the selected audio data in the storage unit 322. In a case where no operating signal is input, the audio data corresponding to the smallest value of component tag values stored in the storage unit 322 is selected. That is to say, in a case where the audio data to be the object of reproducing is not optionally selected, the format selecting unit 333b selects the stream of audio data of which the component tag value is the smallest out of the reproducible audio data. Subsequently, the flow advances the processing in to step S213.

The service notification unit 335b stops output of the GUI screen data that have been output, thereby erasing the list of streams, reads out audio information corresponding. to the selected audio data from the storage unit 322, and outputs the audio information that has been read out to the display unit 318 via the GUI compositing unit, as notification information (step S213). Accordingly, information of the audio mode of the stream of audio data that has been selected is displayed don the display unit 318. Subsequently, the flow advances to the processing in step S214.

The format selecting unit 333b outputs the selected audio data and the format selection signal indicating the audio mode thereof to the amplifying unit 315 (step S214). Accordingly, the audio of the selected steam is reproduced from the amplifying unit 315. Subsequently, the flow returns to the processing in step S201.

### Modifications

The present embodiment can be carried out modified as described next. For example, the processing in step S203 in the processing illustrated in FIG. 21 may be performed after the processing in step S204. Although an example has been described where the component tag and simulcast identification are used as correlation information corresponding to the audio data in the processing in steps S204 and S205, this is not restrictive. The component type and language code (ISO_639_Language_code) may be used instead of or in conjunction with the component tag and simulcast identification.

For example, instead of the processing in step S205, or in the processing in step S205, after determination is made that there is no change in the simulcast group identification (YES in step S205), the format selecting unit 333b determines whether or not audio data corresponding to the same audio mode as the audio mode indicated by the component type corresponding to the audio data selected before updating of the MPT exists (step S205′), [omitted from illustration]. If determining that this exists (YES in step S205′), audio data of which the audio mode is the same is selected, and format selection information indicating the reproduction format of the selected audio data is output to the audio decoding unit 314. Subsequently, the flow advances to the processing in step S201. On the other hand, if determining that this does not exist (NO in step S205′), the flow advances to Che processing in step S206.

Instead of the processing in step S205, after determnation has been made that the simulcast group identification has not chanced in the processing in step S205 (YES in step S205), or after determination has been made that audio data corresponding to the same audio mode does not exist in the processing in step S205′ (NO in step S205′), the format selecting unit 333b determines whether or not audio data corresponding to the same language as the language indicated by the language code corresponding to the audio data selected before updating of the MPT exists (step S205″) [omitted from illustration]. If determining that this exists (YES in step S205″), audio data of which the language is the same is selected, and format selection information indicating the reproduction format of the selected audio data is output to the audio decoding unit 314. Subsequently, the flow advances to the processing in step S201. On the other hand, if determining that this does not exist (NO in step S205″), the flow advances to the processing in step S206.

Beyond this, in a case where audio has been optionally selected before updating of the MPT (YES in step S203), the format selecting unit 333b may determine whether or not there has been any change to a component tag before updating, other than the component tag corresponding to the audio data selected before updating of the MPT (step S203′) [omitted from illustration]. This change is, for example, change in at least any one of audio mode and language of the audio data corresponding to the component tag after updating that is the same as the component tag before updating, or that the component tag after updating has ceased to exist. An arrangement may be made where if there is no change (NO in step S203′), the processing of steps S204, S205, S205′, and S205″ is performed, and if there is change (YES in step S203′), the flow advances to the processing of step S206.

The processing of steps S206 through S210 may be performed before performing the processing of the above-described steps S203, S203′, S204, S205, S205′, and S205″, Also, in the processing of the above-described steps S203, S203′, S204, S205, S205′, and S205″, instead of returning to step S201, the format selecting unit 333b selects the audio data selected at that point in time in step S212. Also, instead of advancing to step S206, the format selecting unit 333b selects audio data relating to a predetermined component tag in step S212.

In a case where the number of audio data of the audio mode regarding which the audio decoding unit 314 has processing capabilities is one, the service notification unit 335b may omit the processing of step S211.

As described above, the reception device 31 according to the present embodiment has the service detecting unit 332 that detects whether or not there has been update in configuration information including correlation information corresponding to audio data provided in a program, from received signals received by broadcasting. The reception device 31 also has the format selecting unit 333b that selects one of multiple audio data in accordance with operating input. The reception device 31 also has the audio decoding unit 314 that decodes audio data selected by the format selecting unit 333b. When configuration information is updated, the format selecting unit 333b selects audio data corresponding to correlation information including a predetermined element that is the same as correlation information corresponding to the audio data selected before the updating, from correlation information included in the updated configuration information.

According to this configuration, audio data corresponding to correlation information including the same predetermined element as correlation information corresponding to the audio data selected before updating the configuration information is selected as audio data to be reproduced after updating of the configuration information. Accordingly, in a case where configuration information is updated by programs switching or the like, audio data is selected that has a predetermined element in the correlation information in common, without the user having to perform new operations. In a case where the predetermined element is used having been correlated with an attribute such as audio mode, language, or the like, audio having the attribute that the user desires is reproduced.

Also, in a case where identification information indicating the presence of audio data having a different attribute that is included in the same correlation information and indicates the same content as the corresponding audio data is the same as identification information included in correlation information corresponding to audio data selected before the updating, the format selecting unit 333b may select the audio data corresponding to the identification information that is the same.

According to this configuration, when simulcast broadcasting is performed before and after updating of configuration information, audio data corresponding to the same correlation information as identification information corresponding to audio data selected before updating of the configuration information is selected as audio data that is the object of reproducing after updating of the configuration information. Accordingly, in a case where the identification information is used having been correlated with an audio data group having an attribute such as audio mode, language, or the like, audio data that has the same identification information as before updating of the configuration information is selected when the type of audio data is maintained. Accordingly, the probabilty that audio of an attribute that the user desires will increase.

The format selecting unit 333b may also select audio data corresponding to the same type information as type information indicating the reproduction mode of the audio data selected before updating the configuration information.

According to this configuration, audio data of the same audio mode as the audio mode of the audio data selected before updating the configuration information is selected as the audio data to be the object of reproducing after updating of the configuration information. Accordingly, in a case where configuration information is updated by programs switching or the like, audio data is selected that has a common audio mode, without the user having to perform new operations.

The format selecting unit 333b may also select audio data corresponding to the same language information as language information indicating the language of the audio data selected before updating the configuration information.

According to this configuration, audio data of the same language as the language of the audio data selected before updating the configuration information is selected as the audio data to be the object of reproducing after updating of the configuration information. Accordingly, in a case where configuration information is updated by programs switching or the like, audio data is selected that has a common language, without the user having to perform new operations.

Also, the format selecting unit 333b selects, of audio data of audio modes that can be processed, the audio data with the smallest identification No., (i) in a case where an identification No. of the same identification No. as audio data included in correlation information corresponding to audio data selected before updating (e.g., a component tag value serving as a predetermined element of the MH-audio component descriptor that is correlation information) does not exist, or (ii) in a case where audio data, of which identification information indicating the presence of audio data having a different attribute indicating the same content as audio data selected before the updating (e.g., simulcast group identification serving as a predetermined element of the MH-audio component descriptor that is correlation information) is the same as identification information included in correlation information corresponding to audio data selected before the updating, does not exist, or (iii) in a case where audio data corresponding to type information the same as type information indicating the audio mode of audio data selected before the updating (e.g., component type serving as a predetermined element of the MH-audio component descriptor that is correlation information) does not exist, or (vi) in a case where audio data corresponding to language information the same as language information indicating the language of audio data selected before the updating (e.g., language code serving as a predetermined element of the MH-audio component descriptor that is correlation information) does not exist.

According to this configuration, the audio data with the smallest identification No. is selected out of audio data of audio modes that can be processed as objects of reproduction, (i) when audio data of the same identification No. as the identification No. of audio data selected before updating of the configuration has ceased to exist, (ii) when the presence or absence of providing of simulcast audio relating to audio data selected before updating of the configuration information, or makeup of the simulcast audio, has changed after updating of the configuration information, (iii) when audio data of the same audio mode as the audio data selected before updating of the configuration information has ceased to exists, or (iv) when audio data of the same language as the language of the audio data selected before updating of the configuration information has ceased to exist. In a case where the broadcaster or program producer performs programming such that the smaller the identification No. of the audio mode is, the higher the allocation priority of audio data to be provided is, audio mode is selected more in accordance with the intent of providing by the broadcaster or program producer.

The reception device 31 may also have the service notification unit 335b that, in a case where audio data of multiple audio modes that can be processed are provided, and there is no correlation information including a predetermined element that is the same as correlation information corresponding to audio data selected before updating present in correlation information included in the updated configuration information, output notification information indicating information of the multiple audio data.

According to this configuration, when correlation information the same as correlation information corresponding to audio data selected before updating of the configuration information does not exist, notification information indicating information of multiple audio data provided in the program is presented. Accordingly, the user can select a desired audio data out of the multiple audio data.

Note that the present invention is not restricted to the above-described embodiments. Various modifications may be made within the scope set forth in the Claims, and embodiments obtained by appropriately combining technical configurations disclosed in different embodiments are also encompassed by the technical scope of the present invention.

Also, components of the present invention can be optionally selected or omitted, and configurations obtained by selecting or omitting are also included in the present invention.

For example, the amplifying unit 315 and display unit 318 may be omitted, as long as various types of data can be exchanged with the reception device 31. The video decoding unit 316 may also be omitted.

A case has been exemplified regarding the format selecting unit 333 in the reception device 31 where a reproduction format with a greater number of audio channels is selected as the higher order reproduction format, but this is not restrictive. For example, if the number of audio channels is the same but the sampling frequency differs among two or more reproduction formats, the format selecting unit 333 may select the reproduction format of which the sampling frequency is higher. Also, if the number of audio channels and the sampling frequency are the same but the quantization precision differs among two or more reproduction formats, the format selecting unit 333 may select the reproduction format of which the quantization precision is higher.

The sampling frequency (sampling_rate) is described in the MH-audio component descriptor (MH-Audio_Component_Descriptor( )) as illustrated in FIG. 4. The quantization precision is described in the MH-audio component descriptor (MH-Audio_Component_Descriptor( )) as sound quality display (quality_indicator). One of mode 1 through 3 can be specified in the sound quality display (quality indicator). Of the modes 1 through 3, the quantization precision of mode 1 is the highest, and becomes lower in the order of modes 1, 2, and 3. Accordingly, the service detecting snits 332 and 332a can identify the sampling frequency and quantization precision for each stream of audio data specified by a component tag from the MH-audio component descriptor (MH-Audio_Component_Descriptor( )).

Although a case has been exemplified in the above-described embodiments where the media transport format according to MMT (MPEG Media Transport) stipulated. by MPEG-H is used as the transmission method for transmitting various types of data, other transmission methods may be used, such as the method stipulated in MPEG-2 Systems for example. The data format regarding transmission, encryption format, and encoding format may be the format or method stipulated in the transmission format.

Also, part of the transmission device 11 and part of the reception device 31 according to the above-described embodiments may be realized by a computer. In this case, this may be realized by recording a program for realizing the control functions in a computer-readable recording medium, reading in the program recorded in the recording medium into a computer system, and executing. Note that “computer system” as used here is a computer system built into a recognition data transmission device, and includes an OS and hardware such as peripheral devices and so forth. “Computer-readable recording medium” refers to a portable medium such as a flexible disk, magneto-optical disc, ROM, CD-ROM, and so forth, and a storage device such as a hard disk built into the computer system. Further, this “computer-readable recording medium” may include that which dynamically stores a program for a short time, such as a communication line in a case of transmitting a program via a network such as the Internet or the like or a communication line such as a telephone line or the like, and in such case, may store the program for a predetermined amount of time such as with volatile memory within a computer system serving as a server or client. The above-described program may be for realizing part of the above-described functions, and may be able to realize the above-described functions in combination with a program already recorded in the computer system.

Some aspects of the present invention may be carried out by the following aspects.

(1) A reception device includes a detecting unit that detects whether or not there has been updating of configuration information including correlation information correlated with audio data provided in a program from reception signals received in a broadcast, a selecting unit that selects one of a plurality of audio data in accordance with operating input, and a decoding unit that decodes audio data that the selecting unit has selected. When the configuration information is updated, the selecting unit selects, out of correlation information included in the configuration information that has been updated, audio data corresponding to correlation information including a predetermined element that is the same as correlation information corresponding to audio data selected before updating.

In the reception device according to (1), in a case where identification information indicating the presence of audio data having a different attribute that is included in the same correlation information and indicates the same content as the corresponding audio data is the same as the identification information included in correlation information corresponding to audio data selected before updating, the selecting unit selects audio data corresponding to the identification information that is the same.

(3) In the reception device according to either (1) or (2), the selecting unit selects audio data corresponding to type information that is the same as type information indicating an audio mode of audio data selected before updating the configuration information.

(4) In the reception device according to any one of (1) through (3), the selecting unit selects audio data corresponding to language information that is the same as language information indicating a language of audio data selected before updating the configuration information.

(5) In the reception device according to any one of (1) through (4), the selecting unit selects audio data with a smallest identification No. out of audio data of audio modes that can be processed, when an identification No. of the same identification No. as audio data included in correlation information corresponding to audio data selected before updating does not exist, or when audio data, of which identification information indicating the presence of audio data having a different attribute indicating the same content as audio data selected before the updating is the same as the identification information included in correlation information corresponding to audio data selected before the updating, does not exist, or when audio data corresponding to type information the same as type information indicating the audio mode of audio data selected before the updating does not exist, or when audio data corresponding to language information the same as language information indicating the language of audio data selected before the updating does not exist.

(6) The reception device according to any one of (1) through (5) further includes a notification unit that, when audio data of multiple audio modes that can be processed are provided in the program, and there is no correlation information including a predetermined element that is the same as correlation information corresponding to audio data selected before updating present in correlation information included in the updated configuration information, outputs notification information indicating the multiple audio data.

(7) A reception method in a reception device includes a detecting process in which whether or not there has been updating of configuration information, including correlation information correlated with audio data provided in a program, is detected from reception signals received in a broadcast, and a selecting process in which one of a plurality of audio data is selected as audio data to be decoded, in accordance with operating input. When the configuration information is updated, audio data corresponding to correlation information including a predetermined element that is the same as correlation information corresponding to audio data selected before updating, is selected out of correlation information. included in updated configuration information.

(8) A program that causes a computer of a reception device to execute a detecting procedure in which whether or not there has been updating of configuration information, including correlation information correlated with audio data provided in a program, is detected from reception signals received in a broadcast, and a selecting procedure in which one of a plurality of audio data is selected as audio data to be decoded, in accordance with operating input. When the configuration information is updated, audio data corresponding to correlation information including a predetermined element that is the same as correlation information corresponding to audio data selected before updating, is selected out of correlation information included in updated configuration information.

### INDUSTRIAL APPLICABILITY

Some aspects of the present invention can be applied to a reception device, a reception method, and a program, that need to select desired audio data when programs are switched.

### REFERENCE SIGNS LIST

1 broadcast system
11 transmission device
111 program data generating unit
112 configuration information generating unit
113 multiplexing unit
114 encrypting unit
115 transmission unit
12 broadcast transmission path
13 broadcast satellite
31 reception device
311 reception unit
312 decryption unit
313 demultiplexing unit
314 audio decoding unit
315 amplifying unit
316 video decoding unit
317 GUI compositing unit
318 display unit
322 storage unit
323 operation input unit
331 control unit
332, 332a, 332d service detecting unit
333, 333b format selecting unit
334 station selecting unit
335b, 335d service notification unit
336c reception programming unit

1. A reception device, comprising:
a detecting unit that detects whether or not there has been updating of configuration information including correlation information correlated with audio data provided in a program from reception signals received in a broadcast;
a selecting unit that selects one of a plurality of audio data in accordance with operating input; and
a decoding unit that decodes audio data that the selecting unit has selected,
wherein, when the configuration information is updated, the selecting unit selects, out of correlation information included in the configuration information that has been updated, audio data corresponding to correlation information including a predetermined element that is the same as correlation information corresponding to audio data selected before updating.

2. The reception device according to claim 1,
wherein, in a case where identification information indicating the presence of audio data having a different attribute that is included in the same correlation information and indicates the same content as the corresponding audio data is the same as the identification information included in correlation information corresponding to audio data selected before updating, the selecting unit selects audio data corresponding to the identification information that is the same.

3. The reception device according to claim 1,
wherein the selecting unit selects audio data corresponding to type information that is the same as type information indicating an audio mode of audio data selected before updating the configuration information,

4. The reception device according to claim 1,
wherein the selecting unit selects audio data corresponding to language information that is the same as language information indicating a language of audio data selected before updating the configuration information.

5. The reception device according to claim 1,
wherein the selecting unit selects audio data with a smallest identification No. out of audio data of audio modes that can be processed,
when an identification No. of the same identification No. as audio data included in correlation information corresponding to audio data selected before updating does not exist,
or when audio data, of which identification information indicating the presence of audio data having a different attribute indicating the same content as audio data selected before the updating is the same as the identification information included in correlation information corresponding to audio data selected before the updating, does not exist,
or when audio data corresponding to type information the same as type information indicating the audio mode of audio data selected before the updating does not exist,
or when audio data corresponding to language information the same as language information indicating the language of audio data selected before the updating does not exist.

6. The reception device according to claim 1, further comprising:
a notification unit that, when audio data of multiple audio modes that can be processed are provided in the program, and there is no correlation information including a predetermined element that is the same as correlation information corresponding to audio data selected before updating present in correlation information included in the updated configuration information, outputs notification information indicating the multiple audio data.

7. A reception method in a reception device, the method comprising:
a detecting process in which whether or not there has been updating of configuration information, including correlation information correlated with audio data provided in a program, is detected from reception signals received in a broadcast; and
a selecting process in which one of a plurality of audio data is selected as audio data to be decoded, in accordance with operating input,
wherein, when the configuration information is updated, audio data corresponding to correlation information including a predetermined element that is the same as correlation information corresponding to audio data selected before updating, is selected out of correlation information included in updated configuration information.

8. A non-transitory recording medium storing a program that causes a computer of a reception device to execute
a detecting procedure in which whether or not there has been updating of configuration information, including correlation information correlated with audio data provided in a program, is detected from reception signals received in a broadcast, and
a selecting procedure in which one of a plurality of audio data is selected as audio data to be decoded, in accordance with operating input,
wherein, when the configuration information is updated, audio data corresponding to correlation information including a predetermined element that is the same as correlation information corresponding to audio data selected before updating, is selected out of correlation information included in updated configuration information.
